(19) United States
(12) Patent Application Publication
(10) Pub. No.: US 2024/0155432 A1
(43) Pub. Date: May 9, 2024

(54) TECHNIQUES FOR INTER-CELL TRAFFIC COORDINATION

(71) Applicant: QUALCOMM Incorporated, San Diego, CA (US)

(72) Inventors: Ahmed Elshafie, San Diego, CA (US); Huilin Xu, Temecula, CA (US); Diana Maamari, San Diego, CA (US); Ahmed Attia Abotabl, San Diego, CA (US)

(21) Appl. No.: 18/054,090

(22) Filed: Nov. 9, 2022

(51) Int. Cl. H04W 28/12; H04L 1/00; H04W 76/14

(52) U.S. Cl. CPC H04W 28/12; H04L 1/0003; H04W 76/14

(57) ABSTRACT

Methods, systems, and devices for wireless communications are described. A network entity associated with a first cell may obtain a control message that includes traffic information associated with a second cell. The traffic information may indicate a first set of communication parameters associated with traffic for communication via the second cell. Based on the traffic information associated with the second cell, the network entity may communicate, via the first cell, a message with a user equipment (UE) associated with the first cell. For example, a second set of communication parameters associated with the message may be based on the traffic information associated with the second cell.

### FIELD OF TECHNOLOGY

The following relates to wireless communications, including techniques for inter-cell traffic coordination.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for inter-cell traffic coordination. For example, the described techniques provide for sharing traffic information between network entities to improve cross-cell coordination and support increased communication quality, among other benefits. For instance, a network entity may collect (e.g., obtain, gather, aggregate) traffic information associated with a cell served by the network entity, and may share the traffic information with one or more other network entities that serve other cells. Additionally or alternatively, the traffic information may be shared with the one or more other network entities, for example, via one or more UEs. In some examples, a network entity may adjust one or more communication parameters based on receiving the traffic information. For example, higher priority communications may be prioritized such that other traffic (e.g., of lesser priority) may be re-scheduled or communication parameters associated with the other traffic may be adjusted to reduce interference with the higher priority communications. Accordingly, adjusting the one or more communication parameters may enable the network entity to improve communications with one or more associated UEs and reduce interference associated with other nearby devices, among other advantages.

A method for wireless communication at a network entity associated with a first cell is described. The method may include obtaining a control message including traffic information associated with a second cell, the traffic information indicating a first set of communication parameters associated with traffic for communicating via the second cell and communicating, via the first cell, a message with a user equipment (UE) associated with the first cell, a second set of communication parameters associated with the message based on the traffic information associated with the second cell.

An apparatus for wireless communication at a network entity associated with a first cell is described. The apparatus may include a processor, memory coupled with the processor, and instructions stored in the memory. The instructions may be executable by the processor to cause the apparatus to obtain a control message including traffic information associated with a second cell, the traffic information indicating a first set of communication parameters associated with traffic for communicating via the second cell and communicating, via the first cell, a message with a UE associate with the first cell, a second set of communication parameters associated with the message based on the traffic information associated with the second cell.

Another apparatus for wireless communication at a network entity associated with a first cell is described. The apparatus may include means for obtaining a control message including traffic information associated with a second cell, the traffic information indicating a first set of communication parameters associated with traffic for communicating via the second cell and means for communicating, via the first cell, a message with a UE associated with the first cell, a second set of communication parameters associated with the message based on the traffic information associated with the second cell.

A non-transitory computer-readable medium storing code for wireless communication at a network entity associated with a first cell is described. The code may include instructions executable by a processor to obtain a control message including traffic information associated with a second cell, the traffic information indicating a first set of communication parameters associated with traffic for communicating via the second cell and communicating, via the first cell, a message with a UE associate with the first cell, a second set of communication parameters associated with the message based on the traffic information associated with the second cell.

In some examples of the method, apparatuses, and non-transitory computer-readable medium described herein, obtaining the control message including the traffic information may include operations, features, means, or instructions for obtaining the control message including the traffic information from a second network entity associated with the second cell.

In some examples of the method, apparatuses, and non-transitory computer-readable medium described herein, obtaining the control message including the traffic information may include operations, features, means, or instructions for obtaining, via the first cell, the control message including the traffic information from the UE or a second UE associated with the first cell.

In some examples of the method, apparatuses, and non-transitory computer-readable medium described herein, outputting, to the UE or the second UE, a request to establish a sidelink to communicate with a third UE associated with the second cell, where the control message including the traffic information may be obtained based on the establishment of the sidelink.

In some examples of the method, apparatuses, and non-transitory computer-readable medium described herein, obtaining the control message including the traffic information may include operations, features, means, or instructions for obtaining the control message including the traffic information from a second UE associated with the second cell.

Some examples of the method, apparatuses, and non-transitory computer-readable medium described herein may further include operations, features, means, or instructions for determining the second set of communication parameters for communicating the message with the UE based on the first set of communication parameters and a priority associated with the message, a quality of service (QoS) associated with the message, or both.

In some examples of the method, apparatuses, and non-transitory computer-readable medium described herein, the first set of communication parameters includes a priority associated with the traffic, a QoS associated with the traffic, a modulation and coding scheme (MCS) associated with the traffic, a transmission power associated with the traffic, a resource configuration associated with the traffic, a reference signal configuration associated with the traffic, a scrambling code associated with the traffic, a transport block size (TBS) associated with the traffic, a buffer status report (BSR) associated with the traffic, channel state information (CSI) associated with the second cell, or a combination thereof and the second set of communication parameters includes a MCS associated with the message, a transmission power associated with the message, a resource configuration associated with the message, or a combination thereof.

Some examples of the method, apparatuses, and non-transitory computer-readable medium described herein may further include operations, features, means, or instructions for allocating a sidelink resource to the UE for communicating with a second UE via a sidelink based on the traffic information associated with the second cell.

Some examples of the method, apparatuses, and non-transitory computer-readable medium described herein may further include operations, features, means, or instructions for obtaining, from the UE, a request to adjust a MCS for communicating with the UE based on the traffic information associated with the second cell, where the second set of communication parameters includes the adjusted MCS based on the request.

In some examples of the method, apparatuses, and non-transitory computer-readable medium described herein, outputting, to the UE based on the traffic information associated with the second cell, an indication of a time overlap between the message and a second message communicated via the second cell in accordance with the first set of communication parameters, where the message may be communicated based on the time overlap.

In some examples of the method, apparatuses, and non-transitory computer-readable medium described herein, the indication of the time overlap includes a bitmap corresponding to a set of semi-persistent scheduling (SPS) communication occasions between the network entity and the UE or to a set of configured grant (CG) communication occasions between the network entity and the UE, the bitmap indicating that the time overlap occurs during a communication occasion corresponding to the message.

In some examples of the method, apparatuses, and non-transitory computer-readable medium described herein, the indication of the time overlap includes a SPS configuration associated with the second cell or a CG associated with the second cell, the time overlap corresponding to an overlap between a SPS configuration associated with the first cell and the SPS configuration associated with the second cell or an overlap between a CG associated with the first cell and the CG associated with the second cell.

In some examples of the method, apparatuses, and non-transitory computer-readable medium described herein, outputting, to the UE, downlink control information that activates a SPS configuration for communicating with the UE, where the downlink control information includes an indication of a MCS associated with the SPS configuration that may be based on the traffic information associated with the second cell.

In some examples of the method, apparatuses, and non-transitory computer-readable medium described herein, outputting, to the UE, a second control message including a SPS configuration for communicating with the UE, the SPS configuration including an indication for the UE to obtain the traffic information associated with the second cell from a second UE associated with the second cell, where the control message may be obtained from the UE based on the SPS configuration.

In some examples of the method, apparatuses, and non-transitory computer-readable medium described herein, the SPS configuration includes the indication based on a priority associated with the SPS configuration.

In some examples of the method, apparatuses, and non-transitory computer-readable medium described herein, the SPS configuration includes a second indication of a duration associated with obtaining the control message from the UE after activation of the SPS configuration, a identifier associated with the second UE, a third indication of a MCS associated with the SPS configuration for communicating to the second UE, or a combination thereof.

In some examples of the method, apparatuses, and non-transitory computer-readable medium described herein, outputting, to the UE, downlink control information to activate the SPS configuration, the downlink control information including a MCS associated with the SPS configuration for communicating to the second UE.

In some examples of the method, apparatuses, and non-transitory computer-readable medium described herein, the traffic for communicating via the second cell may be associated with a zone that includes the UE and a second UE associated with the second cell based on respective geographic locations of the UE and the second UE.

A method for wireless communication at a UE associated with a first cell is described. The method may include receiving a first control message including traffic information associated with a second cell, the traffic information indicating a first set of communication parameters associated with traffic for communicating via the second cell, transmitting, to a network entity associated with the first cell, a second control message including the traffic information associated with the second cell, and communicating, via the first cell, a message with the network entity, a second set of communication parameters associated with the message based on the traffic information associated with the second cell.

An apparatus for wireless communication at a UE associated with a first cell is described. The apparatus may include a processor, memory coupled with the processor, and instructions stored in the memory. The instructions may be executable by the processor to cause the apparatus to receive a first control message including traffic information associated with a second cell, the traffic information indicating a first set of communication parameters associated with traffic for communicating via the second cell, transmit, to a network entity associated with the first cell, a second control message including the traffic information associated with the second cell, and communicating, via the first cell, a message with the network entity, a second set of communication parameters associate with the message based on the traffic information associated with the second cell.

Another apparatus for wireless communication at a UE associated with a first cell is described. The apparatus may include means for receiving a first control message including traffic information associated with a second cell, the traffic information indicating a first set of communication parameters associated with traffic for communicating via the second cell, means for transmitting, to a network entity associated with the first cell, a second control message including the traffic information associated with the second cell, and means for communicating, via the first cell, a message with the network entity, a second set of communication parameters associated with the message based on the traffic information associated with the second cell.

A non-transitory computer-readable medium storing code for wireless communication at a UE associated with a first cell is described. The code may include instructions executable by a processor to receive a first control message including traffic information associated with a second cell, the traffic information indicating a first set of communication parameters associated with traffic for communicating via the second cell, transmit, to a network entity associated with the first cell, a second control message including the traffic information associated with the second cell, and communicating, via the first cell, a message with the network entity, a second set of communication parameters associate with the message based on the traffic information associated with the second cell.

In some examples of the method, apparatuses, and non-transitory computer-readable medium described herein, receiving the first control message may include operations, features, means, or instructions for receiving the first control message from a second network entity associated with the second cell or a second UE associated with the second cell.

Some examples of the method, apparatuses, and non-transitory computer-readable medium described herein may further include operations, features, means, or instructions for transmitting, to the network entity, a third control message including second traffic information associated with uplink communications between the UE and the network entity, where the second set of communication parameters may be based on the second traffic information.

Some examples of the method, apparatuses, and non-transitory computer-readable medium described herein may further include operations, features, means, or instructions for receiving, from the network entity, a request to establish a sidelink to communicate with a second UE associated with the second cell, where the first control message may be received from the second UE based on the establishment of the sidelink.

In some examples of the method, apparatuses, and non-transitory computer-readable medium described herein, the first set of communication parameters includes a priority associated with the traffic, a QoS associated with the traffic, a MCS associated with the traffic, a transmission power associated with the traffic, a resource configuration associated with the traffic, a reference signal configuration associated with the traffic, a scrambling code associated with the traffic, a TBS associated with the traffic, a BSR associated with the traffic, CSI associated with the second cell, or a combination thereof and the second set of communication parameters includes a MCS associated with the message, a transmission power associated with the message, a resource configuration associated with the message, or a combination thereof.

Some examples of the method, apparatuses, and non-transitory computer-readable medium described herein may further include operations, features, means, or instructions for transmitting, to the network entity, a request to adjust a MCS for communicating with the UE based on the traffic information associated with the second cell, where the second set of communication parameters includes the adjusted MCS based on the request.

Some examples of the method, apparatuses, and non-transitory computer-readable medium described herein may further include operations, features, means, or instructions for receiving, from the network entity, an indication of a time overlap between the message and a second message communicated via the second cell in accordance with the first set of communication parameters and performing an interference cancellation procedure in association with communicating the message based on the indication of the time overlap and the first set of communication parameters.

Some examples of the method, apparatuses, and non-transitory computer-readable medium described herein may further include operations, features, means, or instructions for receiving, from the network entity, first downlink control information that activates a first SPS configuration for communicating with the network entity and transmitting, to a second UE associated with the second cell based on the first downlink control information, a request for the traffic information associated with the second cell, the traffic information associated with the second cell including a MCS associated with a second SPS configuration of the second cell, CSI associated with the second cell, or a combination thereof, where the first control message may be received based on the request.

Some examples of the method, apparatuses, and non-transitory computer-readable medium described herein may further include operations, features, means, or instructions for transmitting, to the second UE based on the first downlink control information, a third control message including a MCS associated with the first SPS configuration, CSI associated with the first cell, or a combination thereof.

In some examples of the method, apparatuses, and non-transitory computer-readable medium described herein, the traffic for communicating via the second cell may be associated with a zone that includes the UE and a second UE associated with the second cell based on respective geographic locations of the UE and the second UE.

### BRIEF DESCRIPTION OF THE DRAWINGS

FIG. 1 illustrates an example of a wireless communications system that supports techniques for inter-cell traffic coordination in accordance with one or more aspects of the present disclosure.

FIG. 2 illustrates an example of a wireless communications system that supports techniques for inter-cell traffic coordination in accordance with one or more aspects of the present disclosure.

FIG. 3 illustrates an example of a communication configuration that supports techniques for inter-cell traffic coordination in accordance with one or more aspects of the present disclosure.

FIGS. 4 and 5 illustrates an example of a process flow that supports techniques for inter-cell traffic coordination in accordance with one or more aspects of the present disclosure.

FIGS. 6 and 7 illustrate block diagrams of devices that support techniques for inter-cell traffic coordination in accordance with one or more aspects of the present disclosure.

FIG. 8 illustrates a block diagram of a communications manager that supports techniques for inter-cell traffic coordination in accordance with one or more aspects of the present disclosure.

FIG. 9 illustrates a diagram of a system including a device that supports techniques for inter-cell traffic coordination in accordance with one or more aspects of the present disclosure.

FIGS. 10 and 11 illustrate block diagrams of devices that support techniques for inter-cell traffic coordination in accordance with one or more aspects of the present disclosure.

FIG. 12 illustrates a block diagram of a communications manager that supports techniques for inter-cell traffic coordination in accordance with one or more aspects of the present disclosure.

FIG. 13 illustrates a diagram of a system including a device that supports techniques for inter-cell traffic coordination in accordance with one or more aspects of the present disclosure.

FIGS. 14 through 19 illustrate flowcharts showing methods that support techniques for inter-cell traffic coordination in accordance with one or more aspects of the present disclosure.

### DETAILED DESCRIPTION

Some wireless communication systems may support the communication of low latency and highly reliable messages, such as ultra-reliable low latency communications (URLLC) or extended reality (XR) communications, among others. In some cases, these communications may be communicated with a high priority to limit transmission delay (e.g., within a packet delay budget (PDB)). In some examples, XR communications may be quasi-periodic and may include frequent transmissions of data packets.

In some cases, a network entity may coordinate traffic communicated via a cell served by the network entity to improve reliability and quality of the traffic. For example, the network entity may be aware of XR traffic communicated via the cell and coordinate the traffic such that the XR traffic may be communicated in accordance with latency and reliability constraints. However, such techniques may not account for traffic information associated with other cells which are not associated with the network entity. For instance, in some cases, two (e.g., or more) UEs may be located near one another but served by different network entities via different cells. In such cases, the communications between a UE and the UE's respective network entity may interfere with communications between another UE and the UE's respective network entity, which may impact communication quality (e.g., increase latency, increase jitter, reduce reliability). Thus, communications associated with high reliability and low latency constraints, among other examples, may be adversely impacted due to such inter-cell interference.

Methods, systems, devices, and apparatuses are described herein to support sharing traffic information between cells to improve cross cell coordination for increased communication quality and reliability, among other benefits. For example, a network entity may collect traffic information (e.g., traffic priority, quality of service (QoS) of traffic, traffic characteristics) and share the traffic information with one or more other network entities (e.g., via an X2 or Xn interface) associated with other UEs. Additionally or alternatively, the traffic information may be shared with other network entities via one or more UEs (e.g., via sidelink). For example, a first UE associated with a first cell may establish a sidelink connection with a second UE associated with a second cell. After the sidelink connection is established, the first UE may receive traffic information associated with the second cell from the second UE and share the traffic information with a first network entity associated with the first cell. Additionally or alternatively, in some examples, the first network entity may receive the traffic information directly from the second UE associated with the second cell.

Network entities may coordinate traffic via respective cells based on the shared traffic information, for example, to mitigate the effect of inter-cell interference. For instance, a network entity (e.g., a neighboring or nearby network entity) may select (e.g., modify, adjust, determine) one or more communication parameters (e.g., a modulation and coding scheme (MCS), a transmission power, a resource allocation, a resource configuration, among others) based on receiving the traffic information. For example, high priority and/or low latency communications (e.g., XR traffic, URLLC traffic) may be prioritized such that other traffic may be re-scheduled or have communication parameters adjusted to reduce interference with the high priority communications. Accordingly, adjusting the one or more communication parameters may enable the network entity to improve communications with one or more associated UEs and reduce interference associated with other nearby devices, among other advantages.

Aspects of the disclosure are initially described in the context of wireless communications systems. Aspects of the disclosure are further illustrated by and described with reference to communication schedule, a process flow, apparatus diagrams, system diagrams, and flowcharts that relate to techniques for inter-cell traffic coordination.

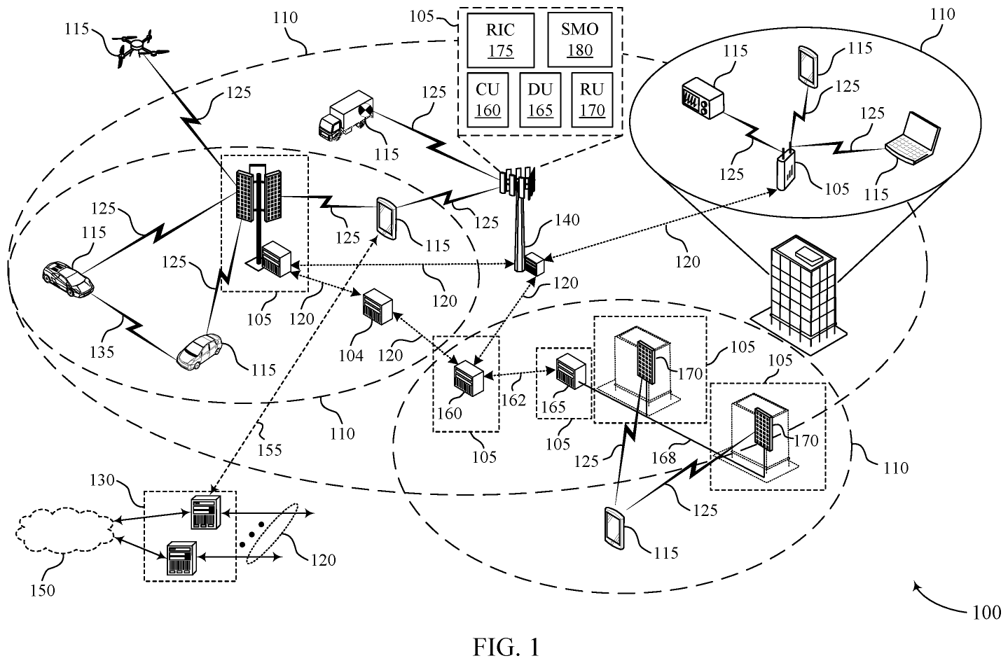

FIG. 1 illustrates an example of a wireless communications system 100 that supports techniques for inter-cell traffic coordination in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for inter-cell traffic coordination as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support communications of messages that have relatively low latency and high reliability constraints (e.g., URLLC, XR communications, among others). For example, the wireless communication system 100 may support XR communications which may include traffic that is quasi-periodic. In some examples, different communication parameters (e.g., constraints) may be associated with different types of XR traffic (e.g., different XR traffic flows). For example, XR downlink video may be associated with a first bit rate (e.g., 10 Megabits per second (Mbps)), a first periodicity (e.g., 20.83 ms), and a first air-link PDB (e.g., 7 ms), among other parameters; XR uplink audio may be associated with a second bit rate (e.g., 0.094 Mbps) a second periodicity (e.g., 20.83 ms), and a second air-link PDB (e.g., 15 ms), among other parameters; and so on for other types of XR traffic. XR traffic may be communicated such that associated communication parameters are satisfied.

In accordance with examples described herein, traffic information (e.g., XR traffic information) may be shared between cells (e.g., network entities 105 associated with different cells) to improve cross cell coordination for increased communication quality. For example, a first network entity 105 serving a first cell may share (e.g., transmit, send, output) traffic information (e.g., uplink traffic information, downlink traffic information, or both) directly with a second network entity 105 serving a second cell or via one or more UEs 115 of the first cell and/or second cell. The first network entity 105 and the second network entity 105 may coordinate the communication of respective traffic via the respective cells based on the shared traffic information. For example, high priority communications (e.g., XR traffic, URLLC traffic) may be prioritized such that other traffic may be re-scheduled or have communication parameters adjusted to reduce interference with the high priority communications and support the communication of the high priority communications in accordance with associated communication constraints.

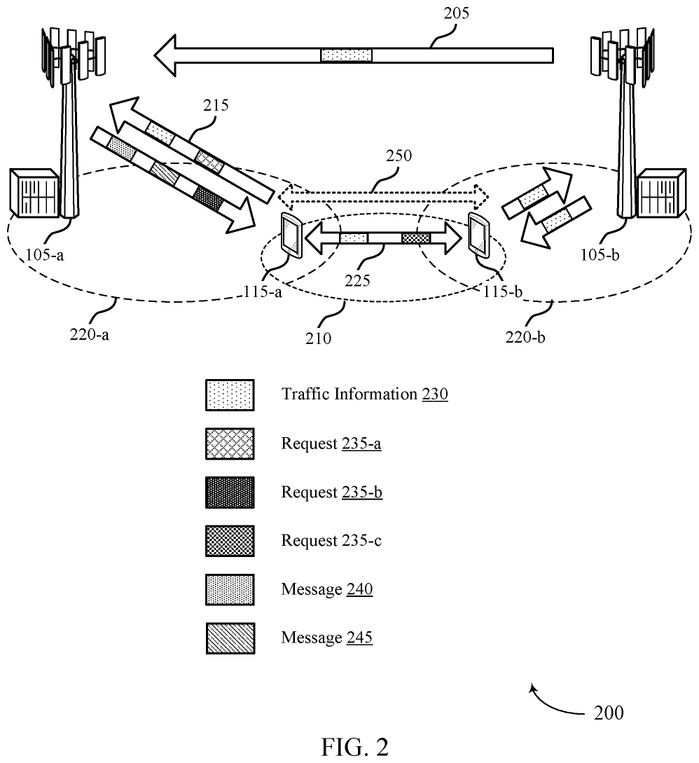

FIG. 2 illustrates an example of a wireless communication system 200 that supports techniques for inter-cell traffic coordination in accordance with one or more aspects of the present disclosure. In some cases, the wireless communications system 200 may implement aspects of the wireless communications system 100 or may be implemented by aspects of the wireless communications system 100. For example, the wireless communications system 200 may include a network entity 105-a, a UE 115-a, a UE 115-b, a network entity 105-b, and communication links 215, which may be examples of network entities 105, UEs 115, and communication links 125, as described with reference to FIG. 1. The network entity 105-a and the network entity 105-b may be associated with a cell 220-a and a cell 220-b, respectively. The cell 220-a and cell 220-b may be associated with respective coverage areas, which may be examples of coverage areas 110 as described with reference to FIG. 1.

The network entity 105-a may communicate with one or more UEs via the cell 220-a. For example, the network entity 105-a may communicate with the UE 115-a via respective communication links 215. The communications between the network entity 105-a and the UE 115-a may, in some cases, include high priority communications such as XR communications, which may also be referred to as XR traffic, among other high priority communications (e.g., URLLC communications). Due to the high priority of XR traffic, it may be beneficial for the network entity 105-a to be aware of the XR traffic communicated via the cell 220-a and associated characteristics (e.g., QoS metrics, application layer attributes, traffic priority). For example, the network entity 105-a may coordinate (e.g., schedule) traffic communicated via the cell 220-a such that communication constraints associated with the XR traffic (e.g., latency constraints, reliability constraints, bit rates, payloads, PDBs, periodicities, among others) are satisfied. As such, the network entity 105-a may track (e.g., collect, determine) traffic information associated with the cell 220-a, including XR traffic information, to support such coordination.

In some examples, messages communicated via respective cells 220 may interfere with each other. For example, the UE 115-a may be located nearby one or more other UEs 115 associated with one or more other cells 220 (e.g., neighboring UEs 115 and cells 220). In some cases, communications associated with the one or more other cells 220 (e.g., uplink or sidelink messages transmitted by the UE 115-b, downlink messages transmitted by the network entity 105-b) may cause interference 250 (e.g., cross link interference (CLI)) with communications between the on the cell 220-a (e.g., and vice versa). In such cases, it may be beneficial for the network entity 105-a to be aware of traffic information 230 associated with the one or more other cells 220 (e.g., via cross cell coordination), in addition to the network entity 105-a's own traffic information 230, to improve the communications with the UE 115-a via the cell 220-a and/or messages communicated via the other cells 220.

In accordance with examples described herein, and in order to increase communication reliability and reduce interference 250, the network entity 105-a may obtain (e.g., receive) traffic information 230 associated with one or more other cells 220 (e.g., the cell 220-b). For example, the traffic information 230 may indicate a first set of communication parameters associated with traffic for communicating via the cell 220-b that may be used by the network entity 105-a to coordinate (e.g., schedule) traffic for communicating via the cell 220-a. For instance, the traffic information 230 may indicate a priority associated with the cell 220-b traffic, a QoS associated with the cell 220-b traffic, an MCS associated with the cell 220-b traffic, a transmission power associated with the cell 220-b traffic, a resource configuration associated with the cell 220-b traffic (e.g., TDD configurations, configured grant (CG) configurations, semi-persistent scheduling (SPS) configurations), a reference signal configuration associated with the cell 220-b traffic (e.g., CSI-RS configurations, demodulation reference signal (DMRS) configurations, sounding reference signal (SRS) configurations, and the like), a scrambling code associated with the cell 220-b traffic, a transport block size (TBS) associated with the cell 220-b traffic, a buffer status report (BSR) associated with the cell 220-b traffic, channel state information (CSI) associated with the cell 220-b, or any combination thereof.

The network entity 105-a may use the first set of communication parameters associated with the cell 220-b traffic to determine (e.g., select, adjust, update) a second set of communication parameters associated with the cell 220-a traffic. For instance, the network entity 105-a may adjust communication parameters, such as MCS, transmission power, beam weights, precoding (e.g., precoding matrices), resource allocations, resource configurations, other parameters, or any combination thereof, to increase communication quality and reduce interference 250. In an example, the network entity 105-a may adjust the communication parameters for UEs 115 that are nearby other UEs 115 which have higher priority traffic (e.g., URLLC traffic, XR traffic) or higher QoS. For example, the network entity 105-a may use the first set of communication parameters to determine a time overlap between traffic between the network entity 105-a and the UE 115-a and traffic between the network entity 105-b and the UE 115-b (e.g., based on the indicated resource allocations, resource configurations, reference signal configurations, BSR, TBS). The network entity 105-a may use the first set of communication parameters to determine that the traffic between the network entity 105-b and the UE 115-b may have a higher priority or a higher QoS than the traffic between the network entity 105-a and the UE 115-a (e.g., based on the indicated priority or QoS). To reduce the interference 250 caused by the traffic between the network entity 105-a and the UE 115-a to the traffic between the network entity 105-b and the UE 115-b, the network entity 105-a may, for example, reduce a transmission power of the traffic, an MCS of the traffic, reschedule the traffic, adjust beam weights or a precoding matrix used to communicate the traffic, or a combination thereof.

In another example, the network entity 105-a may use the first set of communication parameters to determine that traffic for communicating between the network entity 105-a and the UE 115-a may have a higher priority or a higher QoS than overlapping traffic for communicating between the network entity 105-b and the UE 115-b. In some examples, the network entity 105-a may increase a transmission power or reduce an MCS of the traffic, for example, to increase a likelihood that the traffic between the network entity 105-a and the UE 115-a is reliably communicated. For example, the network entity 105-a may determine (e.g., calculate) an expected interference 250 to the traffic using the first set of communication parameters (e.g., the indicated transmission power, the indicated MCS) and adjust the second set of communication parameters to reliably communicate the traffic in view of the expected interference 250. In some examples, traffic information 230 associated with the cell 220-a may have been shared with the network entity 105-b, and the network entity 105-a may rely on the network entity 105-b to (e.g., assume that the network entity 105-b will) adjust communication parameters such that the higher priority and/or QoS traffic between the network entity 105-a and the UE 115-a may be reliably communicated. In the example of FIG. 2, the network entity 105-a and the UE 115-a may communicate a message 240 in accordance with the determined second set of communication parameters.

In some cases, techniques disclosed herein for inter-cell traffic coordination may assist in controlling communication links (e.g., sidelink, Uu link). For example, the UE 115-a and the UE 115-b may operate according to a sidelink mode (e.g., sidelink Mode 1) in which one or more network entities 105 manage the allocation of sidelink resources for use by the UEs 115. In some examples, the network entity 105-a may allocate (e.g., assign) sidelink resources to the UE 115-a (e.g., and the UE 115-b), for example, to reduce interference with higher priority and/or QoS communications (e.g., XR traffic) via other communication links (e.g., a Uu link).

In some examples, the traffic information 230 shared between the network entities 105-a and 105-b may be associated with a subset of the traffic communicated via the cells 220-a and 220-b. For example, the network entity 105-a and the network entity 105-b may determine a group of UEs 210 which are nearby one another (e.g., UE 115-a and UE 115-b may be located geographical near each other). In some examples, the network entity 105-a may use a zone identifier to determine the group of UEs 210. For example, the UE 115-a and the UE 115-b may be located in a same zone that covers a respective geographical area within which the UE 115-a and the UE 115-b are located. Additionally or alternatively, the network entity 105-a and the network entity 105-b may use global positioning system (GPS) data (e.g., a last 8 bits of GPS data), a threshold distance value, CLI information (e.g., UEs 115 for whose communications may result in the interference 250), resource allocation, or any combination thereof to determine the group of UEs 210. The network entity 105-a may determine that the obtained traffic information 230 may apply to one or more UEs in the group of UEs 210. For example, the traffic information 230 collected and shared with the network entities 105-a and 105-b may correspond to traffic for communicating with the UEs 115 of the group of UEs 210. Here, information associated with other traffic communicated via the cells 220 may be excluded from the traffic information 230 shared with the network entities 105-a and 105-b.

The network entity 105-a may obtain the traffic information 230 according to various techniques. In some examples, the network entity 105-a may obtain the traffic information 230 from network entities 105 associated with the other cells 220 (e.g., via a backhaul link, an Xn interface, an X2 interface, some other interface, or any combination thereof). Additionally or alternatively, the network entity 105-a may obtain the traffic information 230 from one or more UEs 115 associated with the cell 220-a (e.g., that communicate with the network entity 105-a via the cell 220-a), one or more UEs 115 associated with one or more other cells 220, or any combination thereof.

In some examples, the network entity 105-b may obtain (e.g., collect) the traffic information 230 associated with the UE 115-b (e.g., uplink traffic information of the UE 115-b, a BSR associated with the UE 115-b) and share the traffic information 230 with the network entity 105-a. That is, the network entity 105-b may aggregate downlink traffic information associated with the cell 220-b (e.g., and specific to the group of UEs 210) with uplink traffic information signaled to the network entity 105-b by the UE 115-b (e.g., via layer 1 (L1), layer 2 (L2), layer 3 (L3) signaling, or a combination thereof). The uplink and downlink traffic information may include respective communication parameters such as traffic priority, traffic QoS, other traffic characteristics, or any combination thereof, as described above. The network entity 105-b may share the traffic information 230 (e.g., both uplink and downlink traffic information) directly with the network entity 105-a via a communication link 205 (e.g., a backhaul link, an Xn interface, an X2 interface, some other network entity-to-network entity interface, or any combination thereof).

Additionally or alternatively, in some examples, the network entity 105-a may obtain the traffic information 230 associated with the cell 220-b via one or more UEs (e.g., the UE 115-a). That is, the UE 115-b may obtain traffic information 230 associated with the cell 220-b from the network entity 105-b. The UE 115-b may transmit the traffic information 230 to the UE 115-a via a sidelink connection 225 (e.g., a PC5 link, a D2D communication link 135). For example, the UE 115-b may share the traffic information 230 via L1, L2, or L3 signaling such as via sidelink control information (SCI), a MAC-control element (MAC-CE), radio resource control (RRC) signaling, or any combination thereof. The UE 115-a may receive the traffic information 230 from the UE 115-b and may transmit the traffic information 230 to the network entity 105-a. In some examples, the UE 115-a may transmit a request 235-a to the network entity 105-a that requests for the network entity 105-a to adjust communication parameters based on the shared traffic information 230. For example, the UE 115-a may transmit the traffic information 230 and the request 235-a to the network entity 105-a via L1, L2, or L3 signaling, such as via uplink control information (UCI) carried on a physical uplink control channel (PUCCH) or a physical uplink shared channel (PUSCH), a MAC-CE, RRC signaling (e.g., user-assistance information indicated via RRC signaling), or any combination thereof. In some cases, obtaining the traffic information 230 from a UE using sidelink may enable faster sharing of the traffic information 230 between network entities 105 relative to direct sharing of the traffic information via the communication link 205.

Additionally, or alternatively, the network entity 105-a may obtain the traffic information 230 associated with the cell 220-b directly from the UE 115-b. That is, the UE 115-b may transmit the traffic information 230 directly to the network entity 105-a instead of via the UE 115-b.

In some examples, the network entity 105-a may transmit a request 235-b to the UE 115-a to establish a sidelink connection 225 (e.g., and establish an RRC connection) with the UE 115-b, which may be in the same group of UEs 210, to obtain the traffic information 230. For example, in response to the request 235-b, the UE 115-a may establish the sidelink connection 225. The UE 115-a may use the sidelink connection 225 to obtain the traffic information 230 associated with the cell 220-b and may transmit the traffic information 230 to the network entity 105-a. In some examples, the UE 115-a may transmit a request 235-c to the UE 115-b that requests for the UE 115-b to transmit the traffic information 230 to the UE 115-a. In response to the request 235-c, the UE 115-b may transmit the traffic information 230 to the UE 115-a via the sidelink connection 225. In some examples, the network entity 105-a may obtain the traffic information 230 from a second UE 115 (not depicted) associated with the cell 220-a, where the second UE 115 obtains the traffic information 230 from the UE 115-b via a respective sidelink connection 225 (e.g., established in response to a respective request 235-b).

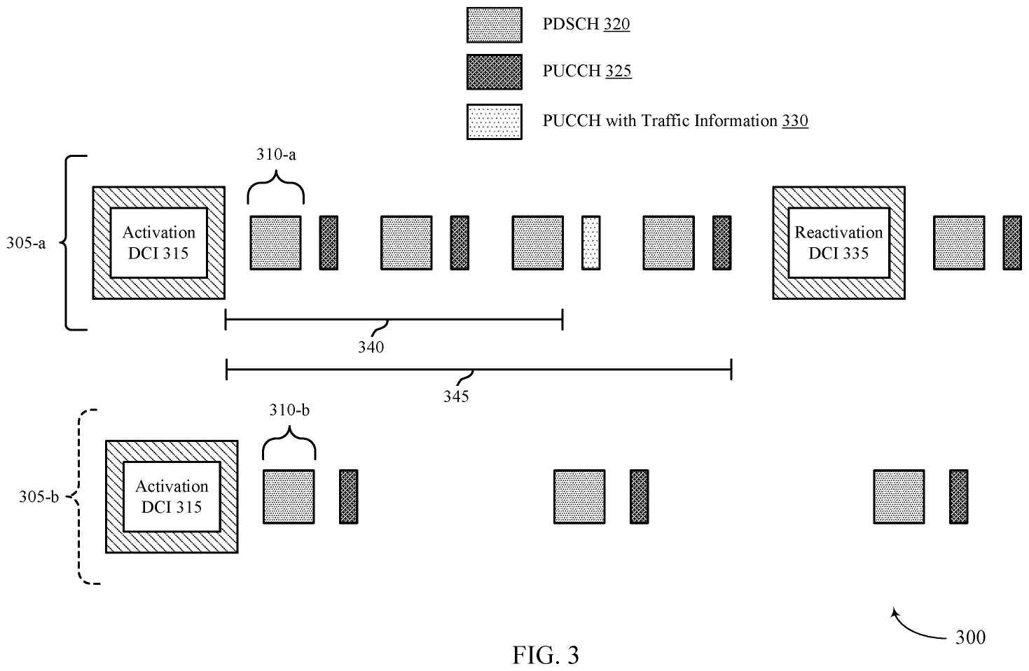

In some examples, the UE 115-a may receive one or more messages 245 from the network entity 105-a based on the traffic information 230 associated with the cell 220-b. For example, the network entity 105-a may transmit the message 245 to indicate the second set of communication parameters to the UE 115-a. In some examples, the message 245 may include a resource configuration (e.g., an SPS configuration, a CG configuration, an adjusted resource configuration) for the UE 115-a to use for communications. In some examples, the message 245 may include an overlap indication that indicates overlapping communication occasions (e.g., SPS communication occasions, CG communication occasions) between the UE 115-a and the UE 115-b. In some examples, the message 245 may include DCI (e.g., activation DCI) that activates a resource configuration (e.g., SPS configuration, CG configuration) in response to which the UE 115-a obtains the traffic information 230 and transmits the traffic information 230 to the network entity 105-a. In some examples, the message 245 may include reactivation DCI to reactivate a resource configuration and indicate the second set of communication parameters for the resource configuration. Additional details related to the communication of traffic information 230 in association with communication according to a resource configuration are described with reference to FIGS. 3 through 5 below.

FIG. 3 illustrates an example of a communication sequence 300 that supports techniques for inter-cell traffic coordination in accordance with one or more aspects of the present disclosure. The communication sequence 300 may be implemented by aspects of the wireless communications systems 100 and 200 described with reference to FIGS. 1 and 2, respectively. For example, the communication sequence 300 may be implemented by a first UE 115 and a first network entity 105 to support inter-cell traffic coordination in association with communicating according to an SPS configuration 305.

For example, the first network entity 105 may indicate (e.g., via a message 245) an SPS configuration 305-a to the first UE 115 according to which the first network entity 105 and the first UE 115 may communicate. The SPS configuration 305-a may include various parameters for communicating SPS messages. For example, the SPS configuration 305-a may include an indication of a time K0 after which the first network entity 105 transmits a PDSCH 320 after activating the SPS configuration 305-a (e.g., via an activation DCI 315). The SPS configuration 305-a may also include an indication of a periodicity P that indicates how often the first network entity 105 transmits respective PDSCHs 320 to the first UE 115. The SPS configuration 305-a may further include a time K1 after reception of a respective PDSCH 320 at which the first UE 115 may transmit a PUCCH 325. Thus, the first network entity 105 may transmit the activation DCI 315 to activate the SPS configuration 305-a, and the first UE 115 and the first network entity 105 may proceed to communicate according to the SPS configuration 305-a.

The first UE 115 and the first network entity 105 may support the communication of traffic information (e.g., traffic information 230) in association with the communication according to the SPS configuration 305-a. For example, a second UE 115 and a second network entity 105 (e.g., associated with a different cell than the first UE 115 and the first network entity 105) may communicate according to an SPS configuration 305-b. In some examples, one or more communication occasions 310 of the SPS configurations 305 (e.g., a time interval during which a PDSCH 320 or a PUCCH 325 is communicated) may overlap in time. For example, a communication occasion 310-a of the SPS configuration 305-a may at least partially overlap in time with a communication occasion 310-b of the SPS configuration 305-b. In some examples, traffic information shared with the first network entity 105 and the second network entity 105 may include an indication of the SPS configuration 305-b and the SPS configuration 305-a, respectively.

Accordingly, the overlap of the communication occasions 310 may be determined and communication may be adjusted to compensate for (e.g., reduce an impact of interference associated with) the overlap. For example, the first network entity 105-a may output an indication of the time overlap (e.g., via a control message including the SPS configuration 305-a, via the activation DCI). The first UE 115 may use the indication of the time overlap to determine that the communication occasion 310-a may be interfered with by a message communicated during the communication occasion 310-b. The first UE 115 may perform an interference cancellation procedure (e.g., on resource elements or resource blocks experiencing interference) to reduce an impact of the interference and increase a reliability of the PDSCH 320 communicated during the communication occasion 310-a.

In some examples, the indication of the time overlap may include a bitmap corresponding to the communication occasions 310 of the SPS configuration 305-a. Each bit of the bitmap may indicate whether a corresponding communication occasion 310 overlaps in time with a communication occasion 310 associated with other communication devices (e.g., the second UE 115, the second network entity 105). In some examples, each bit of the bitmap may indicate whether a corresponding resource block or resource element of a communication occasion 310 overlaps in time with another communication occasion 310. In the example of FIG. 3, the bitmap may indicate that the time overlap occurs during the communication occasion 310-a (e.g., and one or more other communication occasions 310 in which a time overlap occurs).

In some examples, the indication of the time overlap may include the SPS configuration 305-b. Here, the first UE 115 may use the SPS configuration 305-b to determine during which communication occasions 310 the time overlap may occur (e.g., the communication occasion 310-a, among others).

In some examples, the first UE 115 may be configured to obtain traffic information associated with the cell of the second UE 115 and second network entity 105 (e.g., original traffic information, additional traffic information not previously shared) in response to activation of the SPS configuration 305-a. For example, a control message indicating the SPS configuration 305-a to the first UE 115 may include an indication for the first UE 115 to obtain the traffic information from the second UE 115. Based on the indication, the first UE 115 may transmit a request to the second UE 115 for the traffic information in response to receiving the activation DCI 315. In response to the request, the second UE 115 may transmit the traffic information to the first UE 115. In some examples, the second UE 115 may transmit a request to the first UE 115 for traffic information associated with the cell of the first UE 115 and the first network entity 105 in response to which the first UE 115 may transmit the traffic information to the second UE 115.

The traffic information shared between the first UE 115 and the second UE 115 may include various communication parameters associated with the respective SPS configurations 305. For example, the traffic information obtained from the second UE 115 may include an MCS associated with the SPS configuration 305-b (e.g., an MCS used in communicating messages according to the SPS configuration 305-b), CSI associated with communications between the second UE 115 and the second network entity 105, a TDD configuration associated with the communications, a reference signal configuration associated with the communications, a scrambling code associated with the communications, or a combination thereof. The traffic information transmitted by the first UE 115 to the second UE 115 may include similar communication parameters associated with the SPS configuration 305-a and communications between the first UE 115 and the first network entity 105.

The SPS configuration 305-a (e.g., the control message including the SPS configuration 305-a) may include various information to support the sharing of the traffic information between the first UE 115 and the second UE 115. For example, the SPS configuration 305-a may include an identifier associated with another UE 115 from which the first UE 115 is to obtain the traffic information (e.g., an identifier of another UE 115 in the same zone as the first UE 115). Here, the identifier may be an identifier of the second UE 115, which may enable the first UE 115 to identify to which UE 115 to transmit the request for the traffic information (e.g., the second UE 115).

Additionally or alternatively, the SPS configuration 305-a may include an indication of the MCS associated with the SPS configuration 305-a such that the first UE 115 may share it with the second UE 115. The SPS configuration 305-b may similarly include an indication of the MCS associated with the SPS configuration 305-b such that the second UE 115 may share it with the first UE 115.

Additionally or alternatively, the SPS configuration 305-a may include an indication of a duration 340 associated with obtaining the traffic information from the second UE 115 after activation of the SPS configuration 305-a. For example, sharing the traffic information between the first UE 115 and the second UE 115 may take some time after activation of the SPS configuration 305-a. The duration 340 may correspond to a minimum duration for sharing the traffic information after which the sharing is assumed to be completed. The first UE 115 may transmit the traffic information obtained from the second UE 115 via a first PUCCH 325 following an expiration of the duration 340 (e.g., a PUCCH 330). In some examples, the SPS configuration 305-a may include a duration In some examples, the duration 340 may be indicated as a quantity of PDSCHs 320 after activation of the SPS configuration 305-a (e.g., three PDSCHs 320 in the example of FIG. 3). In some examples, the duration 340 may be indicated as a quantity of time intervals (e.g., slots, subframes, mini-slots, and the like). In some examples, the duration 340 may be indicated as an absolute time value (e.g., a quantity of milliseconds).

In some examples, the SPS configuration 305-a may include an indication of a duration 345 corresponding to a maximum duration for sharing the traffic information (e.g., and transmitting the traffic information to the first network entity 105). For example, if the first network entity 105 does not receive a PUCCH 330 including the traffic information by an expiration of the duration 345, the first network entity 105 may determine that the traffic information was not obtained by the first UE 115.

In some examples, one or more of the indications included in the SPS configuration 305-a to support traffic information sharing may instead be included in the activation DCI 315. For example, the indication to obtain the traffic information from the second UE 115, the indication of the MCS associated with the SPS configuration 305-a, the indication of the identifier associated with the second UE 115, the indication of the duration 340, the indication of the duration 345, or a combination thereof, may be included in the activation DCI 315.

In some examples, traffic information corresponding to an SPS configuration 305 associated with lower priority communications may be shared, while traffic information corresponding to an SPS configuration associated with higher priority communications may not be shared. For example, in the example of FIG. 3, the SPS configuration 305-a may be associated with lower priority communications relative to the SPS configuration 305-b. In some cases, the first UE 115 may obtain the traffic information from the second UE 115 but may not transmit respective traffic information to the second UE 115 based on the SPS configuration 305-a being associated with the lower priority communications.

Based on the traffic information obtained from the first UE 115, the first network entity 105 may adjust one or more communication parameters associated with the SPS configuration 305-a. For example, if the MCS associated with the SPS configuration 305-b is relatively high, the first network entity 105 may determine that the second UE 115 is relatively close to the second network entity 105. In some examples, the first network entity 105 may reduce a transmission power or an MCS associated with the SPS configuration 305-a to reduce interference caused by overlapping SPS communications of the SPS configuration 305-a. Additionally or alternatively, the reduction in MCS associated with the SPS configuration 305-a may increase a reliability of the corresponding SPS communications such that there is a greater likelihood of proper decoding by the first UE 115 during communication occasions 310 interfered with by communications between the second UE 115 and the second network entity 105. In some examples, the PUCCH 330 (e.g., the traffic information included in the PUCCH 330) may include a recommendation of an updated MCS for the SPS configuration 305-a determined by the first UE 115 based on the obtained traffic information. In some cases, the PUCCH 330 may include the recommendation and exclude any other obtained traffic information.

To signal the adjusted communication parameters to the first UE 115, the first network entity 105 may transmit a reactivation DCI 335 that includes an indication of the adjusted communication parameters. The first UE 115 and the first network entity 105 may then communicate subsequent PDSCHs 320 and PUCCHs 325 in accordance with the adjusted communication parameters.

In some examples, the indication of the time overlap (e.g., a second indication of a time overlap) may be included in the reactivation DCI 335. For example, if traffic information is not shared until after activation of the SPS configuration 305-a, the reactivation DCI 335 may include an indication of the time overlap for communication occasions 310 subsequent to the reactivation DCI 335 to support interference cancellation by the first UE 115.

The first UE 115 and the first network entity 105 may additionally or alternatively support communicating according to a CG configuration. For example, the first network entity 105 may transmit a control message to the first UE 115 that includes a configuration for CG-PUSCH transmissions (e.g., a periodicity of the CG-PUSCH transmissions, a resource allocation for the CG-PUSCH transmissions) by the first UE 115 to the first network entity 105. In some examples, the control message may activate the CG configuration (e.g., the CG-PUSCH transmissions). In some other examples, the first network entity 105 may transmit an activation DCI 315 to activate the CG configuration.

If communicating according to a CG configuration, the traffic information may be shared between the first network entity 105 and the second network entity 105 (e.g., via a communication link 205). For example, the first network entity 105 may transmit to the second network entity 105 and/or obtain from the second network entity 105 respective traffic information. The first network entity 105 may use the traffic information to determine overlapping communications occasions 310 between a CG configuration of the first network entity 105 and the first UE 115 and a CG configuration of the second network entity 105 and the second UE 115. The first network entity 105 may transmit an indication of the overlapping communication occasions 310 to the first UE 115, which may perform an interference cancellation procedure accordingly. Additionally or alternatively, the first network entity 105 may adjust one or more communication parameters of the corresponding CG configuration based on the traffic information similarly to adjusting the SPS configuration 305-a. In some examples, the updated communication parameters may be signaled to the first UE 115 via a second control message to activate the CG configuration or via reactivation DCI 335.

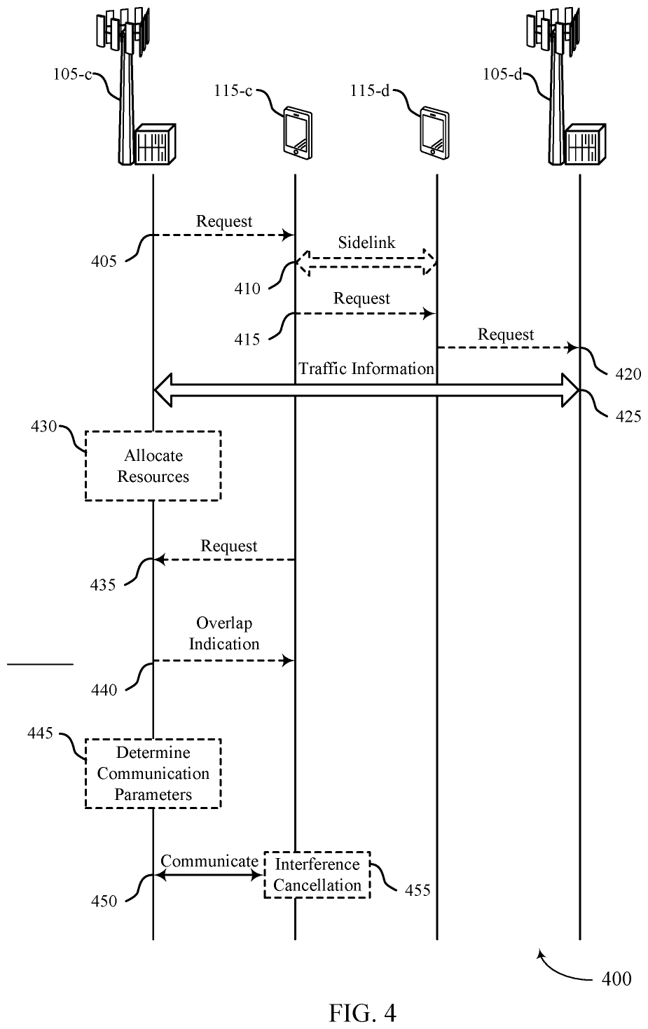

FIG. 4 illustrates an example of a process flow 400 that supports techniques for inter-cell traffic coordination in accordance with one or more aspects of the present disclosure. In some examples, process flow 400 may implement aspects of wireless communications system 100 or wireless communications system 200. For example, process flow 400 may support configurations for obtaining traffic information associated with other cells (e.g., neighboring cells) and adjusting communication parameters based on the traffic information.

The network entities 105-c and 105-d and the UEs 115-c and 115-d may be examples of the corresponding devices as described herein, including with reference to FIGS. 1 through 3. In the following description of process flow 400, the operations between network entity 105-c, UE 115-c, UE 115-d, and network entity 105-d may be transmitted in a different order than the order shown, or other operations may be added or removed from the process flow 400. For example, some operations may also be left out of process flow 400, or may be performed in different orders or at different times. Although network entity 105-c, UE 115-c, UE 115-d, and network entity 105-d are shown performing the operations of process flow 400, some aspects of some operations may also be performed by one or more other wireless or network devices.

At 405, the network entity 105-c may output (e.g., transmit), to the UE 115-c, a first request to establish a sidelink to communicate with a UE 115-d. For example, the UE 115-c and the network entity 105-c may communicate via a first cell, and the UE 115-d and the network entity 105-d may communicate via a second cell. The first request may request for the UE 115-c to perform an RRC connection procedure to establish a sidelink with the UE 115-d such that the UE 115-c and the UE 115-d may exchange sidelink messages (e.g., despite being associated with different cells).

At 410, based on the first request from the network entity 105-c, the UE 115-c may establish a sidelink (e.g., a sidelink connection 225) to communicate with the UE 115-d associated with the second cell. For example, the UE 115-c may perform the RRC connection procedure to establish the sidelink with the UE 115-d.

At 415, the UE 115-c may transmit, to the UE 115-d based on the first request, a second request for traffic information associated with the second cell. For example, the UE 115-c may transmit the second request via the established sidelink.

At 420, based on the second request, the UE 115-d may transmit a third request to the network entity 105-d requesting the traffic information associated with the second cell (e.g., downlink information associated with the second cell) from the network entity 105-d.

At 425, the network entity 105-c may obtain a control message including the traffic information associated with a second cell. The traffic information may indicate a first set of communication parameters associated with traffic for communicating via the second cell. In some examples, the first set of communication parameters may include a priority associated with the traffic, a QoS associated with the traffic, an MCS associated with the traffic, a transmission power associated with the traffic, a resource configuration associated with the traffic (e.g., an SPS configuration, a CG configuration), a reference signal configuration associated with the traffic (e.g., a CSI-RS configuration, a DMRS configuration, an SRS configuration), a scrambling code associated with the traffic, a TBS associated with the traffic, a BSR associated with the traffic, CSI associated with the second cell, or a combination thereof.

In some examples, the network entity 105-c may obtain the control message including the traffic information directly from the network entity 105-d associated with the second cell. Additionally or alternatively, the network entity 105-c may obtain, via the first cell, the control message including the traffic information from the UE 115-c or a second UE 115 associated with the first cell (not depicted). Here, the UE 115-c may receive the traffic information from the UE 115-d or the network entity 105-d (e.g., in response to the second request) and may transmit, to the network entity 105-c associated with the first cell, the control message including the traffic information associated with the second cell. In some examples, the UE 115-c may transmit a second control message (e.g., or include in the control message) additional traffic information corresponding to uplink traffic information associated with the UE 115-c (e.g., uplink communications between the UE 115-c and the network entity 105-c). Additionally or alternatively, the network entity 105-c may obtain the control message including the traffic information directly from the UE 115-d. In some examples, the traffic for communicating via the second cell is associated with a zone that includes the UE 115-c and the UE 115-d based on respective geographic locations of the UE 115-c and the UE 115-d. That is, the traffic information may be specific to the UEs 115 included in the zone.

At 430, the network entity 105-c may allocate a sidelink resource to the UE 115-c for communicating with the UE 115-d via a sidelink (e.g., the sidelink established at 410) based on the traffic information associated with the second cell obtained at 425. For example, in accordance with the traffic information, the network entity 105-c may allocate sidelink resources to the UE 115-c, the UE 115-d, other UEs 115 (e.g., located within the zone) to reduce interference caused by or experienced by sidelink messages communicated via the sidelink resources.

At 435, the network entity 105-c may obtain, from the UE 115-c (e.g., the UE 115-c may transmit), a request to adjust an MCS for communicating with the UE 115-c based on the traffic information associated with the second cell obtained at 425. For example, the UE 115-c may obtain and use the traffic information to determine an adjusted MCS for communicating with the network entity 105-c and may transmit the request accordingly.

At 440, the network entity 105-c may output, to the UE 115-c based on the traffic information associated with the second cell obtained at 425, an indication of a time overlap between a first message communicated via the first cell and a second message communicated via the second cell in accordance with the first set of communication parameters. In some examples, the first message may be communicated based on the time overlap. In some examples, the indication of the time overlap may include a bitmap corresponding to a set of SPS communication occasions between the network entity 105-c and the UE 115-c or to a set of CG communication occasions between the network entity 105-c and the UE 115-c. The bitmap may indicate that the time overlap occurs during a communication occasion corresponding to the first message.

Alternatively, the indication of the time overlap may include an SPS configuration associated with the second cell or a CG associated with the second cell. Here, the UE 115-c may use the indicated SPS configuration or CG configuration to determine the time overlap with the UE 115-c's own SPS configuration or CG configuration. For example, the time overlap may correspond to an overlap between an SPS configuration associated with the first cell and the SPS configuration associated with the second cell or an overlap between a CG associated with the first cell and the CG associated with the second cell.

At 445, the network entity 105-c may determine a second set of communication parameters for communicating a message with the UE 115-c based on the first set of communication parameters and a priority associated with the message, a QoS associated with the message, or both. For example, based on the first set of communication parameters and priority and/or QoS information corresponding to the message, the network entity 105-c may determine the second set of communication parameters including an MCS associated with the message, a transmission power associated with the message, a resource configuration associated with the message, or a combination thereof.

At 450, the network entity 105-c may communicate, via the first cell, the message with the UE 115-c associated with the first cell in accordance with the second set of communication parameters.

At 455, the UE 115-c may perform an interference cancellation procedure in association with communicating the message at 450. In some examples, the interference cancellation procedure may be based on the indication of the time overlap at 440 and the first set of communication parameters. For example, the UE 115-c may use MCS information, resource allocations, or scrambling codes, among other information included in the first set of communication parameters, to perform the interference cancellation procedure and increase a reliability of the message.

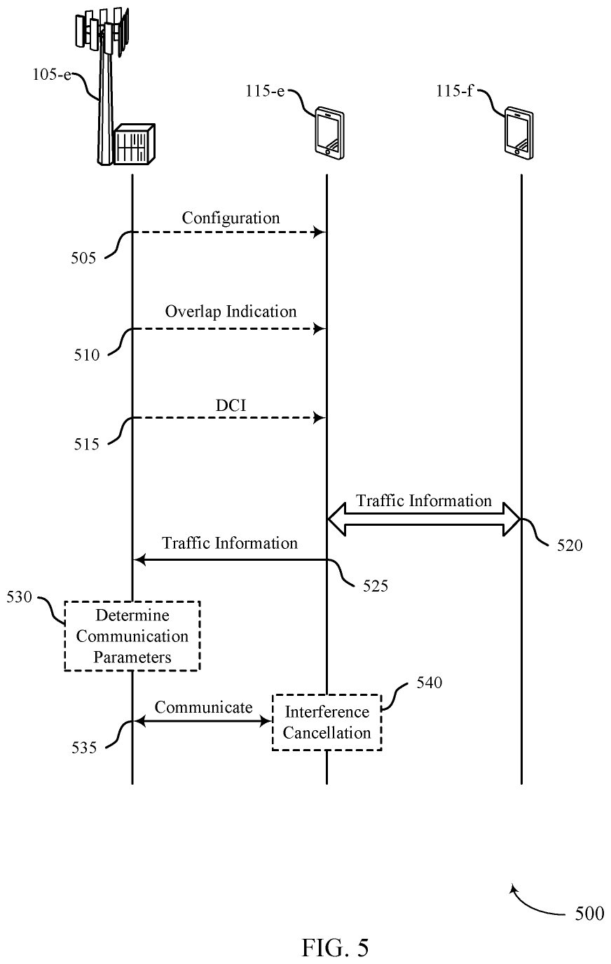

FIG. 5 illustrates an example of a process flow 500 that supports techniques for inter-cell traffic coordination in accordance with one or more aspects of the present disclosure. In some examples, process flow 500 may implement aspects of wireless communications system 100 or wireless communications system 200. For example, process flow 500 may support configurations for obtaining traffic information associated with other cells (e.g., neighboring cells) and adjusting communication parameters based on the traffic information.

The network entities 105-e and the UEs 115-e and 115-f may be examples of the corresponding devices as described herein, including with reference to FIGS. 1 through 3. In the following description of process flow 500, the operations between network entity 105-e, UE 115-e, and UE 115-f may be transmitted in a different order than the order shown, or other operations may be added or removed from the process flow 500. For example, some operations may also be left out of process flow 500, or may be performed in different orders or at different times. Although network entity 105-e, UE 115-e, and UE 115-f, are shown performing the operations of process flow 500, some aspects of some operations may also be performed by one or more other wireless or network devices.

At 505, the network entity 105-e may output, to the UE 115-e, a control message including a configuration for communicating with the UE 115-e via a first cell served by the network entity 105-e. In some examples, the configuration may include an SPS configuration or a CG configuration. The configuration may further include an indication for the UE 115-e to obtain traffic information associated with a second cell from the UE 115-f associated with the second cell. In some examples, the configuration may include the indication based on a priority associated with the SPS configuration or the CG configuration. For example, the configuration may include the indication based on a priority of the configuration satisfying (e.g., being greater than, being greater than or equal to) a threshold priority.

In some examples, the configuration at 505 may include a second indication of a duration associated with obtaining a third control message from the UE 115-f after activation of the configuration. In some examples, the configuration may include an identifier associated with the UE 115-f, an indication of an MCS associated with the SPS configuration (e.g., or CG configuration) for communicating with the network entity 105-e, or a combination thereof.

At 510, the network entity 105-e may output, to the UE 115-e based on the configuration, an indication of a time overlap between one or more messages communicated via the first cell and one or more messages communicated via the second cell. In some examples, the indication of the time overlap may include a bitmap corresponding to a set of SPS communication occasions between the network entity 105-e and the UE 115-e or to a set of CG communication occasions between the network entity 105-e and the UE 115-e. In such examples, the bitmap may indicate that the time overlap occurs during communication occasion corresponding to the one or more messages communicated via the first cell.

Additionally or alternatively, the indication of the time overlap may include an SPS configuration associated with the second cell or a CG associated with the second cell. In some examples, the time overlap may correspond to an overlap between an SPS configuration associated with the first cell and the SPS configuration associated with the second cell or an overlap between a CG associated with the first cell and the CG associated with the second cell.

At 515, the network entity 105-e may output, to the UE 115-e, a DCI that activates the configuration (e.g., SPS configuration, CG configuration) for communicating with the UE 115-e. In some examples, the DCI includes an indication of an MCS associated with the configuration

At 520, the UE 115-f may share the traffic information associated with the second cell with the UE 115-e. Additionally or alternatively, the UE 115-e may share traffic information associated with the first cell with the UE 115-f. In some examples, the UE 115-e may transmit a request to the UE 115-f to obtain the traffic information.

At 525, the UE 115-e may transmit, to the network entity 105-e, a control message including the traffic information. In some examples, the UE 115-e may also transmit a control message including traffic information associated with uplink communications between the UE 115-e and the network entity 105-e.

At 530, the network entity 105-e may determine a second set of communication parameters for communicating a message with the UE 115-e based on the traffic information and a priority associated with the message, a QoS associated with the message, or both. In some examples, the second set of communication parameters may include an MCS associated with the message, a transmission power associated with the message, a resource configuration associated with the message, or a combination thereof.

At 535, the network entity 105-e may communicate, via the first cell, the message with the UE 115-e associated with the first cell in accordance with the second set of communication parameters.

At 540, the UE 115-e may perform an interference cancellation procedure in association with communicating the message at 540. In some examples, the interference cancellation procedure may be based on the indication of the time overlap at 510 and the first set of communication parameters.

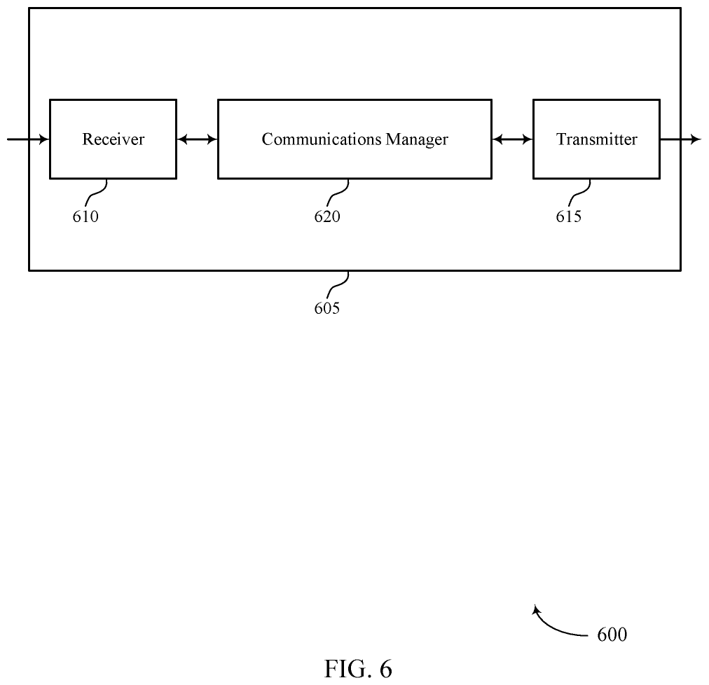

FIG. 6 illustrates a block diagram 600 of a device 605 that supports techniques for inter-cell traffic coordination in accordance with one or more aspects of the present disclosure. The device 605 may be an example of aspects of a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations thereof or various components thereof may be examples of means for performing various aspects of techniques for inter-cell traffic coordination as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a network entity associated with a first cell in accordance with examples as disclosed herein. For example, the communications manager 620 may be configured as or otherwise support a means for obtaining a control message including traffic information associated with a second cell, the traffic information indicating a first set of communication parameters associated with traffic for communicating via the second cell. The communications manager 620 may be configured as or otherwise support a means for communicating, via the first cell, a message with a UE associated with the first cell, a second set of communication parameters associated with the message based on the traffic information associated with the second cell.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for more efficient processing, reduced power consumption, and more efficient utilization of communication resources.

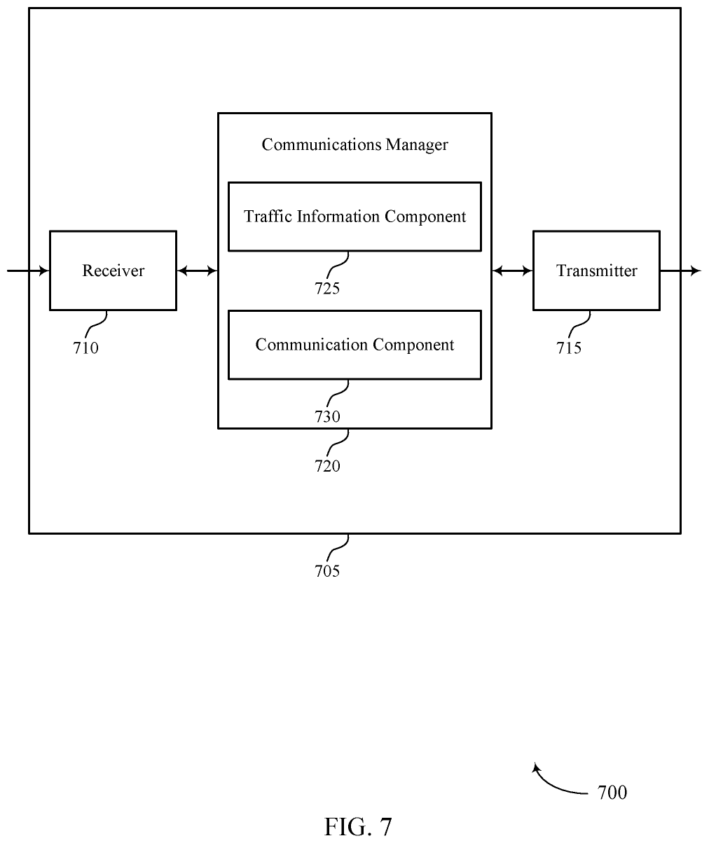

FIG. 7 illustrates a block diagram 700 of a device 705 that supports techniques for inter-cell traffic coordination in accordance with one or more aspects of the present disclosure. The device 705 may be an example of aspects of a device 605 or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of techniques for inter-cell traffic coordination as described herein. For example, the communications manager 720 may include a traffic information component 725 a communication component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a network entity associated with a first cell in accordance with examples as disclosed herein. The traffic information component 725 may be configured as or otherwise support a means for obtaining a control message including traffic information associated with a second cell, the traffic information indicating a first set of communication parameters associated with traffic for communicating via the second cell. The communication component 730 may be configured as or otherwise support a means for communicating, via the first cell, a message with a UE associated with the first cell, a second set of communication parameters associated with the message based on the traffic information associated with the second cell.

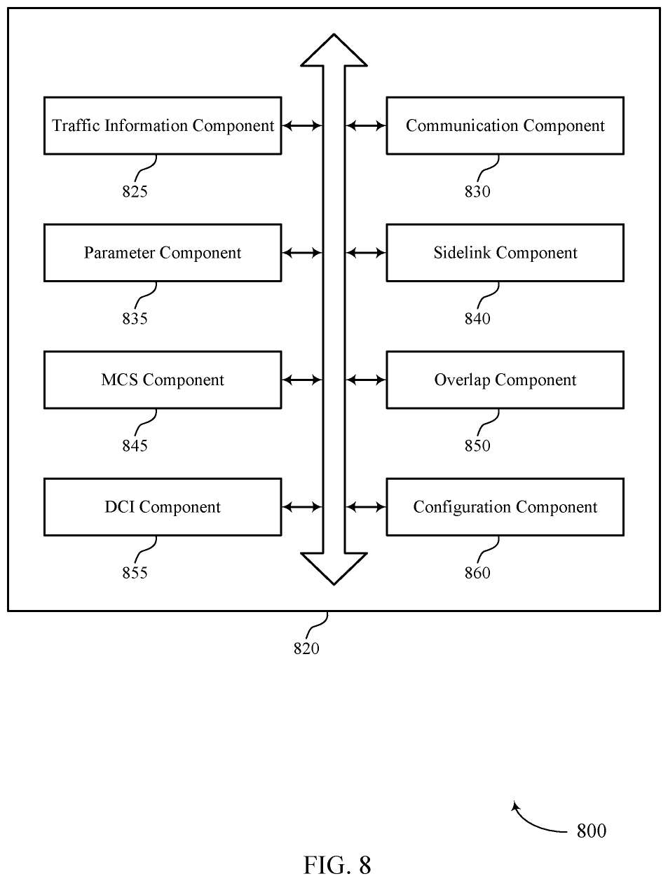

FIG. 8 illustrates a block diagram 800 of a communications manager 820 that supports techniques for inter-cell traffic coordination in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for inter-cell traffic coordination as described herein. For example, the communications manager 820 may include a traffic information component 825, a communication component 830, a parameter component 835, a sidelink component 840, an MCS component 845, an overlap component 850, a DCI component 855, a configuration component 860, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communication at a network entity associated with a first cell in accordance with examples as disclosed herein. The traffic information component 825 may be configured as or otherwise support a means for obtaining a control message including traffic information associated with a second cell, the traffic information indicating a first set of communication parameters associated with traffic for communicating via the second cell. The communication component 830 may be configured as or otherwise support a means for communicating, via the first cell, a message with a UE associated with the first cell, a second set of communication parameters associated with the message based on the traffic information associated with the second cell.

In some examples, to support obtaining the control message including the traffic information, the traffic information component 825 may be configured as or otherwise support a means for obtaining the control message including the traffic information from a second network entity associated with the second cell.

In some examples, to support obtaining the control message including the traffic information, the communication component 830 may be configured as or otherwise support a means for obtaining, via the first cell, the control message including the traffic information from the UE or a second UE associated with the first cell.

In some examples, the sidelink component 840 may be configured as or otherwise support a means for outputting, to the UE or the second UE, a request to establish a sidelink to communicate with a third UE associated with the second cell, where the control message including the traffic information is obtained based on the establishment of the sidelink.

In some examples, to support obtaining the control message including the traffic information, the traffic information component 825 may be configured as or otherwise support a means for obtaining the control message including the traffic information from a second UE associated with the second cell.

In some examples, the parameter component 835 may be configured as or otherwise support a means for determining the second set of communication parameters for communicating the message with the UE based on the first set of communication parameters and a priority associated with the message, a QoS associated with the message, or both.

In some examples, the first set of communication parameters includes a priority associated with the traffic, a QoS associated with the traffic, an MCS associated with the traffic, a transmission power associated with the traffic, a resource configuration associated with the traffic, a reference signal configuration associated with the traffic, a scrambling code associated with the traffic, a TBS associated with the traffic, a BSR associated with the traffic, CSI associated with the second cell, or a combination thereof. In some examples, the second set of communication parameters includes an MCS associated with the message, a transmission power associated with the message, a resource configuration associated with the message, or a combination thereof.

In some examples, the sidelink component 840 may be configured as or otherwise support a means for allocating a sidelink resource to the UE for communicating with a second UE via a sidelink based on the traffic information associated with the second cell.

In some examples, the MCS component 845 may be configured as or otherwise support a means for obtaining, from the UE, a request to adjust an MCS for communicating with the UE based on the traffic information associated with the second cell, where the second set of communication parameters includes the adjusted MCS based on the request.

In some examples, the overlap component 850 may be configured as or otherwise support a means for outputting, to the UE based on the traffic information associated with the second cell, an indication of a time overlap between the message and a second message communicated via the second cell in accordance with the first set of communication parameters, where the message is communicated based on the time overlap.

In some examples, the indication of the time overlap includes a bitmap corresponding to a set of SPS communication occasions between the network entity and the UE or to a set of CG communication occasions between the network entity and the UE, the bitmap indicating that the time overlap occurs during a communication occasion corresponding to the message.

In some examples, the indication of the time overlap includes an SPS configuration associated with the second cell or a CG associated with the second cell, the time overlap corresponding to an overlap between an SPS configuration associated with the first cell and the SPS configuration associated with the second cell or an overlap between a CG associated with the first cell and the CG associated with the second cell.

In some examples, the DCI component 855 may be configured as or otherwise support a means for outputting, to the UE, DCI that activates an SPS configuration for communicating with the UE, where the DCI includes an indication of an MCS associated with the SPS configuration that is based on the traffic information associated with the second cell.

In some examples, the configuration component 860 may be configured as or otherwise support a means for outputting, to the UE, a second control message including an SPS configuration or CG configuration for communicating with the UE, the SPS configuration or CG configuration including an indication for the UE to obtain the traffic information associated with the second cell from a second UE associated with the second cell, where the control message is obtained from the UE based on the SPS configuration or CG configuration.

In some examples, the SPS configuration or CG configuration includes the indication based on a priority associated with the SPS configuration or CG configuration.

In some examples, the SPS configuration or CG configuration includes a second indication of a duration associated with obtaining the control message from the UE after activation of the SPS configuration or (e.g., activation or transmission of) the CG configuration, an identifier associated with the second UE, a third indication of an MCS associated with the SPS configuration or CG configuration for communicating to the second UE, or a combination thereof.

In some examples, the DCI component 855 may be configured as or otherwise support a means for outputting, to the UE, DCI to activate the SPS configuration or CG configuration, the DCI including an MCS associated with the SPS configuration or CG configuration for communicating to the second UE.

In some examples, the traffic for communicating via the second cell is associated with a zone that includes the UE and a second UE associated with the second cell based on respective geographic locations of the UE and the second UE.

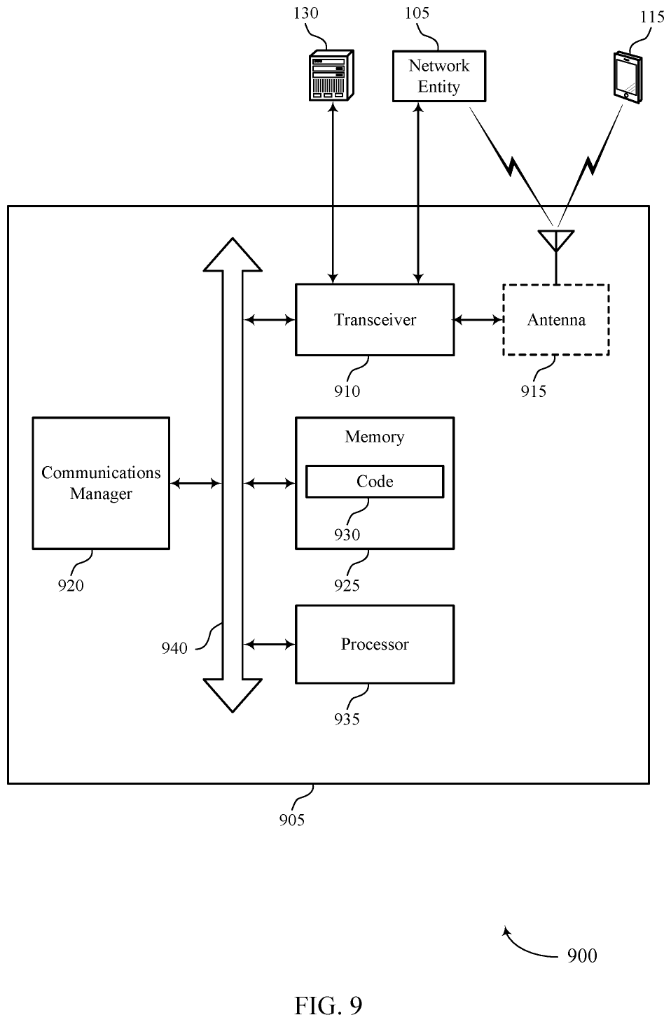

FIG. 9 illustrates a diagram of a system 900 including a device 905 that supports techniques for inter-cell traffic coordination in accordance with one or more aspects of the present disclosure. The device 905 may be an example of or include the components of a device 605, a device 705, or a network entity 105 as described herein. The device 905 may communicate with one or more network entities 105, one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, a memory 925, code 930, and a processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or memory components (for example, the processor 935, or the memory 925, or both), may be included in a chip or chip assembly that is installed in the device 905. In some examples, the transceiver may be operable to support communications via one or more communications links (e.g., a communication link 125, a backhaul communication link 120, a midhaul communication link 162, a fronthaul communication link 168).

The memory 925 may include RAM and ROM. The memory 925 may store computer-readable, computer-executable code 930 including instructions that, when executed by the processor 935, cause the device 905 to perform various functions described herein. The code 930 may be stored in a non-transitory computer-readable medium such as system memory or another type of memory. In some cases, the code 930 may not be directly executable by the processor 935 but may cause a computer (e.g., when compiled and executed) to perform functions described herein. In some cases, the memory 925 may contain, among other things, a BIOS which may control basic hardware or software operation such as the interaction with peripheral components or devices.

The processor 935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 935 may be configured to operate a memory array using a memory controller. In some other cases, a memory controller may be integrated into the processor 935. The processor 935 may be configured to execute computer-readable instructions stored in a memory (e.g., the memory 925) to cause the device 905 to perform various functions (e.g., functions or tasks supporting techniques for inter-cell traffic coordination). For example, the device 905 or a component of the device 905 may include a processor 935 and memory 925 coupled with the processor 935, the processor 935 and memory 925 configured to perform various functions described herein. The processor 935 may be an example of a cloud-computing platform (e.g., one or more physical nodes and supporting software such as operating systems, virtual machines, or container instances) that may host the functions (e.g., by executing code 930) to perform the functions of the device 905. The processor 935 may be any one or more suitable processors capable of executing scripts or instructions of one or more software programs stored in the device 905 (such as within the memory 925). In some implementations, the processor 935 may be a component of a processing system. A processing system may generally refer to a system or series of machines or components that receives inputs and processes the inputs to produce a set of outputs (which may be passed to other systems or components of, for example, the device 905). For example, a processing system of the device 905 may refer to a system including the various other components or subcomponents of the device 905, such as the processor 935, or the transceiver 910, or the communications manager 920, or other components or combinations of components of the device 905. The processing system of the device 905 may interface with other components of the device 905, and may process information received from other components (such as inputs or signals) or output information to other components. For example, a chip or modem of the device 905 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 905 may transmit information output from the chip or modem. Additionally, or alternatively, in some implementations, the one or more interfaces may refer to an interface between the processing system of the chip or modem and a receiver, such that the device 905 may obtain information or signal inputs, and the information may be passed to the processing system. A person having ordinary skill in the art will readily recognize that a first interface also may obtain information or signal inputs, and a second interface also may output information or signal outputs.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the memory 925, the code 930, and the processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with other network entities 105, and may include a controller or scheduler for controlling communications with UEs 115 in cooperation with other network entities 105. In some examples, the communications manager 920 may support an X2 interface within an LTE/LTE-A wireless communications network technology to provide communication between network entities 105.

The communications manager 920 may support wireless communication at a network entity associated with a first cell in accordance with examples as disclosed herein. For example, the communications manager 920 may be configured as or otherwise support a means for obtaining a control message including traffic information associated with a second cell, the traffic information indicating a first set of communication parameters associated with traffic for communicating via the second cell. The communications manager 920 may be configured as or otherwise support a means for communicating, via the first cell, a message with a UE associated with the first cell, a second set of communication parameters associated with the message based on the traffic information associated with the second cell.

By including or configuring the communications manager 920 in accordance with examples as described herein, the device 905 may support techniques for improved communication reliability, reduced latency, reduced interference, more efficient utilization of communication resources, and improved coordination between devices.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, the processor 935, the memory 925, the code 930, or any combination thereof. For example, the code 930 may include instructions executable by the processor 935 to cause the device 905 to perform various aspects of techniques for inter-cell traffic coordination as described herein, or the processor 935 and the memory 925 may be otherwise configured to perform or support such operations.

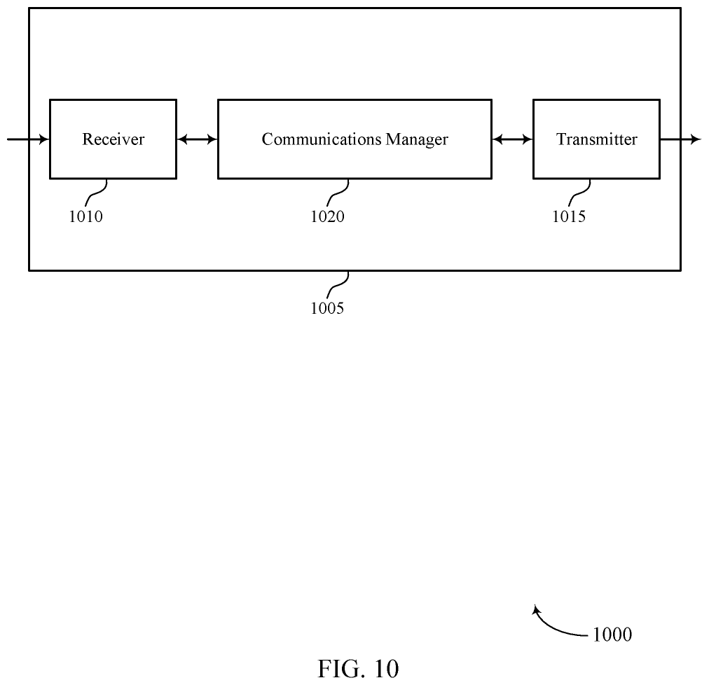

FIG. 10 illustrates a block diagram 1000 of a device 1005 that supports techniques for inter-cell traffic coordination in accordance with one or more aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for inter-cell traffic coordination). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for inter-cell traffic coordination). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of techniques for inter-cell traffic coordination as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a UE associated with a first cell in accordance with examples as disclosed herein. For example, the communications manager 1020 may be configured as or otherwise support a means for receiving a first control message including traffic information associated with a second cell, the traffic information indicating a first set of communication parameters associated with traffic for communicating via the second cell. The communications manager 1020 may be configured as or otherwise support a means for transmitting, to a network entity associated with the first cell, a second control message including the traffic information associated with the second cell. The communications manager 1020 may be configured as or otherwise support a means for communicating, via the first cell, a message with the network entity, a second set of communication parameters associated with the message based on the traffic information associated with the second cell.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for more efficient processing, reduced power consumption, and more efficient utilization of communication resources.

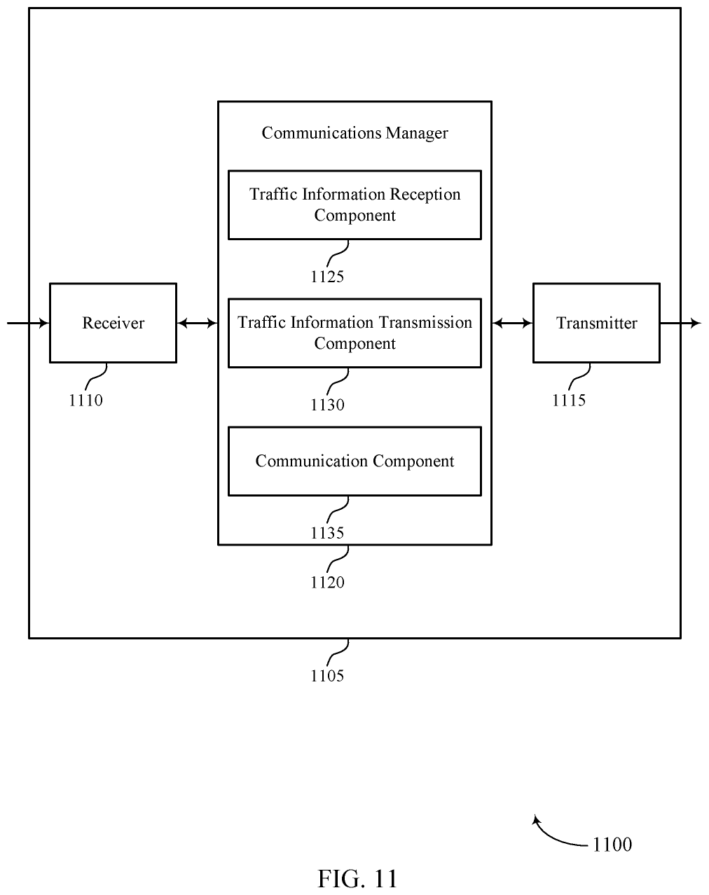

FIG. 11 illustrates a block diagram 1100 of a device 1105 that supports techniques for inter-cell traffic coordination in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for inter-cell traffic coordination). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for inter-cell traffic coordination). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of techniques for inter-cell traffic coordination as described herein. For example, the communications manager 1120 may include a traffic information reception component 1125, a traffic information transmission component 1130, a communication component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a UE associated with a first cell in accordance with examples as disclosed herein. The traffic information reception component 1125 may be configured as or otherwise support a means for receiving a first control message including traffic information associated with a second cell, the traffic information indicating a first set of communication parameters associated with traffic for communicating via the second cell. The traffic information transmission component 1130 may be configured as or otherwise support a means for transmitting, to a network entity associated with the first cell, a second control message including the traffic information associated with the second cell. The communication component 1135 may be configured as or otherwise support a means for communicating, via the first cell, a message with the network entity, a second set of communication parameters associated with the message based on the traffic information associated with the second cell.

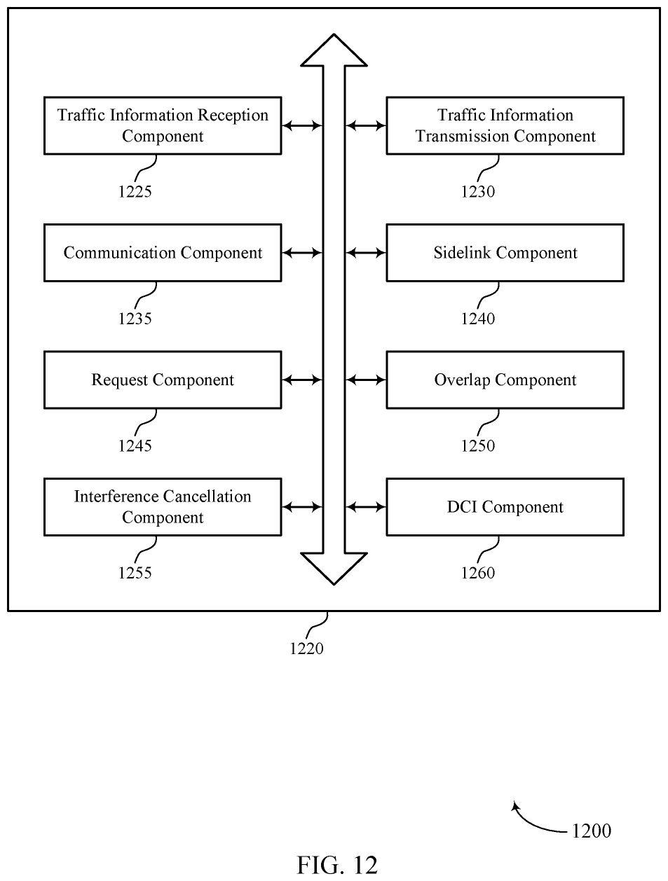

FIG. 12 illustrates a block diagram 1200 of a communications manager 1220 that supports techniques for inter-cell traffic coordination in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for inter-cell traffic coordination as described herein. For example, the communications manager 1220 may include a traffic information reception component 1225, a traffic information transmission component 1230, a communication component 1235, a sidelink component 1240, a request component 1245, an overlap component 1250, an interference cancellation component 1255, a DCI component 1260, or any combination thereof. Each of these components may communicate, directly or indirectly, with one another (e.g., via one or more buses).

The communications manager 1220 may support wireless communication at a UE associated with a first cell in accordance with examples as disclosed herein. The traffic information reception component 1225 may be configured as or otherwise support a means for receiving a first control message including traffic information associated with a second cell, the traffic information indicating a first set of communication parameters associated with traffic for communicating via the second cell. The traffic information transmission component 1230 may be configured as or otherwise support a means for transmitting, to a network entity associated with the first cell, a second control message including the traffic information associated with the second cell. The communication component 1235 may be configured as or otherwise support a means for communicating, via the first cell, a message with the network entity, a second set of communication parameters associated with the message based on the traffic information associated with the second cell.

In some examples, to support receiving the first control message, the traffic information reception component 1225 may be configured as or otherwise support a means for receiving the first control message from a second network entity associated with the second cell or a second UE associated with the second cell.

In some examples, the traffic information transmission component 1230 may be configured as or otherwise support a means for transmitting, to the network entity, a third control message including second traffic information associated with uplink communications between the UE and the network entity, where the second set of communication parameters are based on the second traffic information.

In some examples, the sidelink component 1240 may be configured as or otherwise support a means for receiving, from the network entity, a request to establish a sidelink to communicate with a second UE associated with the second cell, where the first control message is received from the second UE based on the establishment of the sidelink.

In some examples, the first set of communication parameters includes a priority associated with the traffic, a QoS associated with the traffic, an MCS associated with the traffic, a transmission power associated with the traffic, a resource configuration associated with the traffic, a reference signal configuration associated with the traffic, a scrambling code associated with the traffic, a TBS associated with the traffic, a BSR associated with the traffic, CSI associated with the second cell, or a combination thereof. In some examples, the second set of communication parameters includes an MCS associated with the message, a transmission power associated with the message, a resource configuration associated with the message, or a combination thereof.

In some examples, the request component 1245 may be configured as or otherwise support a means for transmitting, to the network entity, a request to adjust an MCS for communicating with the UE based on the traffic information associated with the second cell, where the second set of communication parameters includes the adjusted MCS based on the request.

In some examples, the overlap component 1250 may be configured as or otherwise support a means for receiving, from the network entity, an indication of a time overlap between the message and a second message communicated via the second cell in accordance with the first set of communication parameters. In some examples, the interference cancellation component 1255 may be configured as or otherwise support a means for performing an interference cancellation procedure in association with communicating the message based on the indication of the time overlap and the first set of communication parameters.

In some examples, the DCI component 1260 may be configured as or otherwise support a means for receiving, from the network entity, first DCI that activates a first SPS configuration or CG configuration for communicating with the network entity. In some examples, the request component 1245 may be configured as or otherwise support a means for transmitting, to a second UE associated with the second cell based on the first DCI, a request for the traffic information associated with the second cell, the traffic information associated with the second cell including an MCS associated with a second SPS configuration of the second cell, CSI associated with the second cell, or a combination thereof, where the first control message is received based on the request.

In some examples, the traffic information transmission component 1230 may be configured as or otherwise support a means for transmitting, to the second UE based on the first DCI, a third control message including an MCS associated with the first SPS configuration or CG configuration, CSI associated with the first cell, or a combination thereof.

In some examples, the traffic for communicating via the second cell is associated with a zone that includes the UE and a second UE associated with the second cell based on respective geographic locations of the UE and the second UE.

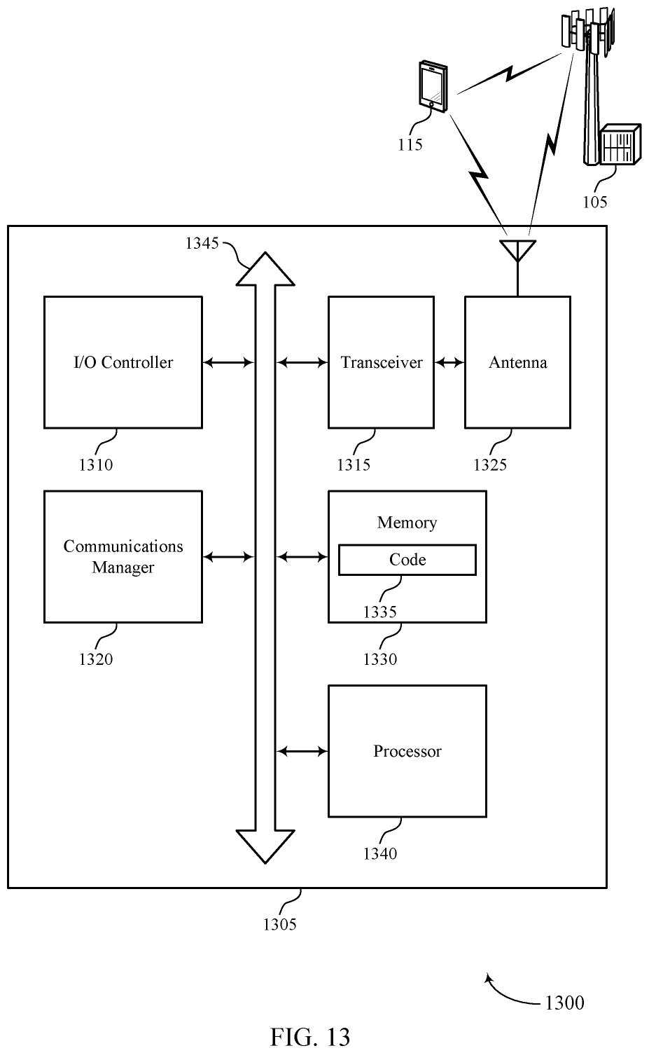

FIG. 13 illustrates a diagram of a system 1300 including a device 1305 that supports techniques for inter-cell traffic coordination in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting techniques for inter-cell traffic coordination). For example, the device 1305 or a component of the device 1305 may include a processor 1340 and memory 1330 coupled with or to the processor 1340, the processor 1340 and memory 1330 configured to perform various functions described herein.

The communications manager 1320 may support wireless communication at a UE associated with a first cell in accordance with examples as disclosed herein. For example, the communications manager 1320 may be configured as or otherwise support a means for receiving a first control message including traffic information associated with a second cell, the traffic information indicating a first set of communication parameters associated with traffic for communicating via the second cell. The communications manager 1320 may be configured as or otherwise support a means for transmitting, to a network entity associated with the first cell, a second control message including the traffic information associated with the second cell. The communications manager 1320 may be configured as or otherwise support a means for communicating, via the first cell, a message with the network entity, a second set of communication parameters associated with the message based on the traffic information associated with the second cell.

By including or configuring the communications manager 1320 in accordance with examples as described herein, the device 1305 may support techniques for improved communication reliability, reduced latency, reduced interference, more efficient utilization of communication resources, and improved coordination between devices.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of techniques for inter-cell traffic coordination as described herein, or the processor 1340 and the memory 1330 may be otherwise configured to perform or support such operations.

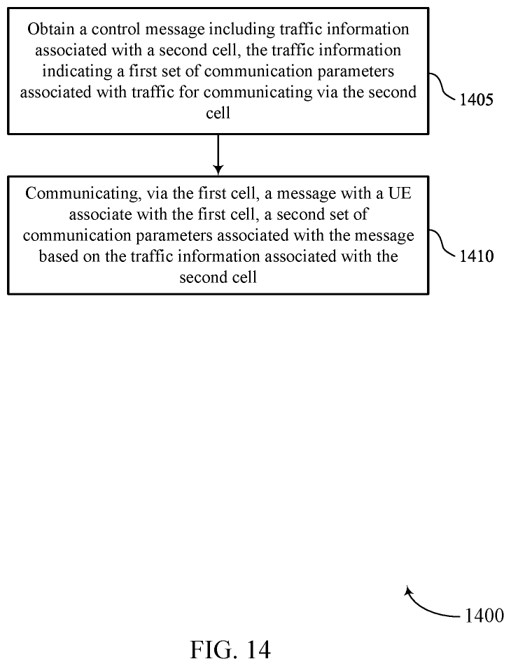

FIG. 14 illustrates a flowchart illustrating a method 1400 that supports techniques for inter-cell traffic coordination in accordance with one or more aspects of the present disclosure. The operations of the method 1400 may be implemented by a network entity or its components as described herein. For example, the operations of the method 1400 may be performed by a network entity associated with a first cell as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1405, the method may include obtaining a control message including traffic information associated with a second cell, the traffic information indicating a first set of communication parameters associated with traffic for communicating via the second cell. The operations of 1405 may be performed in accordance with examples as disclosed herein. In some examples, aspects of the operations of 1405 may be performed by a traffic information component 825 as described with reference to FIG. 8.

At 1410, the method may include communicating, via the first cell, a message with a UE associated with the first cell, a second set of communication parameters associated with the message based on the traffic information associated with the second cell. The operations of 1410 may be performed in accordance with examples as disclosed herein. In some examples, aspects of the operations of 1410 may be performed by a communication component 830 as described with reference to FIG. 8.

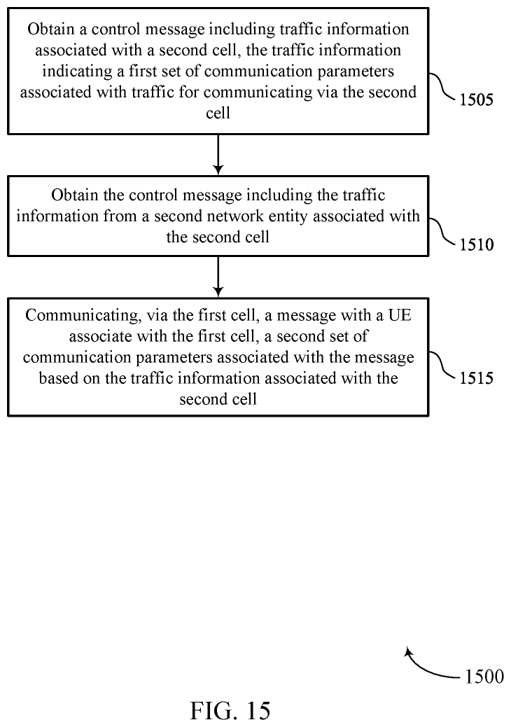

FIG. 15 illustrates a flowchart illustrating a method 1500 that supports techniques for inter-cell traffic coordination in accordance with one or more aspects of the present disclosure. The operations of the method 1500 may be implemented by a network entity or its components as described herein. For example, the operations of the method 1500 may be performed by a network entity associated with a first cell as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1505, the method may include obtaining a control message including traffic information associated with a second cell, the traffic information indicating a first set of communication parameters associated with traffic for communicating via the second cell. The operations of 1505 may be performed in accordance with examples as disclosed herein. In some examples, aspects of the operations of 1505 may be performed by a traffic information component 825 as described with reference to FIG. 8.

At 1510, to support obtaining the control message, the method may include obtaining the control message including the traffic information from a second network entity associated with the second cell. The operations of 1510 may be performed in accordance with examples as disclosed herein. In some examples, aspects of the operations of 1510 may be performed by a traffic information component 825 as described with reference to FIG. 8.

At 1515, the method may include communicating, via the first cell, a message with a UE associated with the first cell, a second set of communication parameters associated with the message based on the traffic information associated with the second cell. The operations of 1515 may be performed in accordance with examples as disclosed herein. In some examples, aspects of the operations of 1515 may be performed by a communication component 830 as described with reference to FIG. 8.

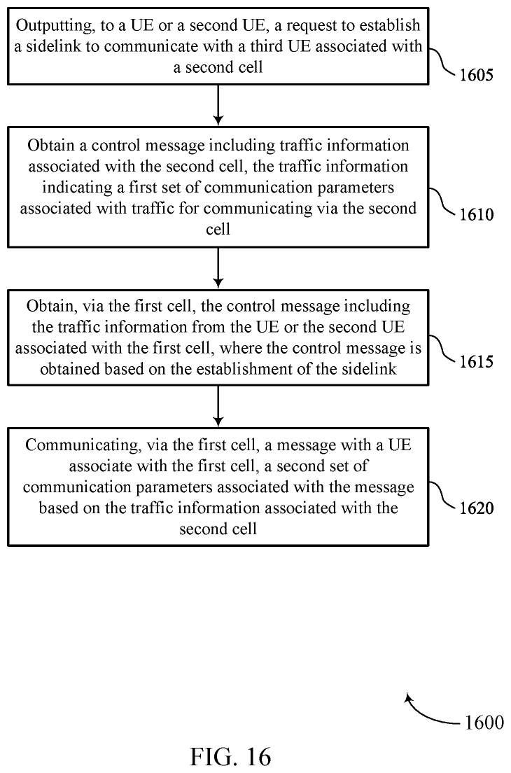

FIG. 16 illustrates a flowchart illustrating a method 1600 that supports techniques for inter-cell traffic coordination in accordance with one or more aspects of the present disclosure. The operations of the method 1600 may be implemented by a network entity or its components as described herein. For example, the operations of the method 1600 may be performed by a network entity associated with a first cell as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1605, the method may include outputting, to a UE or a second UE, a request to establish a sidelink to communicate with a third UE associated with a second cell. The operations of 1605 may be performed in accordance with examples as disclosed herein. In some examples, aspects of the operations of 1605 may be performed by a sidelink component 840 as described with reference to FIG. 8.

At 1610, the method may include obtaining a control message including traffic information associated with a second cell, the traffic information indicating a first set of communication parameters associated with traffic for communicating via the second cell. The operations of 1610 may be performed in accordance with examples as disclosed herein. In some examples, aspects of the operations of 1610 may be performed by a traffic information component 825 as described with reference to FIG. 8.

At 1615, to support obtaining the control message, the method may include obtaining, via the first cell, the control message including the traffic information from the UE or a second UE associated with the first cell, where the control message is obtained based on the establishment of the sidelink. The operations of 1615 may be performed in accordance with examples as disclosed herein. In some examples, aspects of the operations of 1615 may be performed by a communication component 830 as described with reference to FIG. 8.

At 1620, the method may include communicating, via the first cell, a message with a UE associated with the first cell, a second set of communication parameters associated with the message based on the traffic information associated with the second cell. The operations of 1620 may be performed in accordance with examples as disclosed herein. In some examples, aspects of the operations of 1620 may be performed by a communication component 830 as described with reference to FIG. 8.

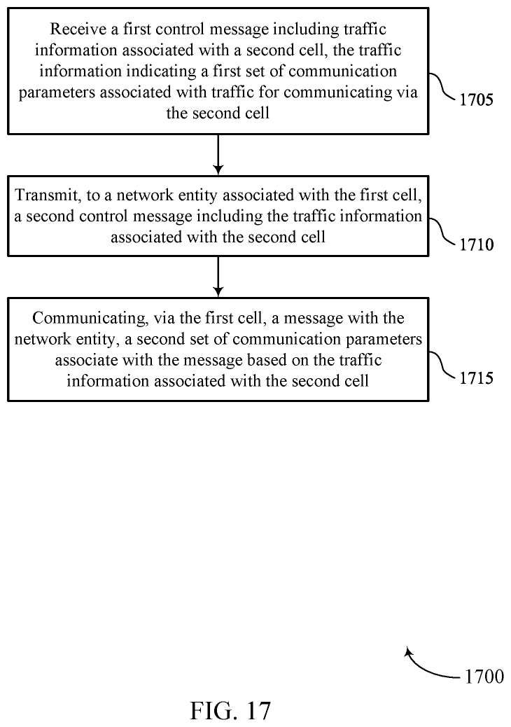

FIG. 17 illustrates a flowchart illustrating a method 1700 that supports techniques for inter-cell traffic coordination in accordance with one or more aspects of the present disclosure. The operations of the method 1700 may be implemented by a UE or its components as described herein. For example, the operations of the method 1700 may be performed by a UE 115 associated with a first cell as described with reference to FIGS. 1 through 5 and 10 through 13. In some examples, a UE may execute a set of instructions to control the functional elements of the UE to perform the described functions. Additionally, or alternatively, the UE may perform aspects of the described functions using special-purpose hardware.

At 1705, the method may include receiving a first control message including traffic information associated with a second cell, the traffic information indicating a first set of communication parameters associated with traffic for communicating via the second cell. The operations of 1705 may be performed in accordance with examples as disclosed herein. In some examples, aspects of the operations of 1705 may be performed by a traffic information reception component 1225 as described with reference to FIG. 12.

At 1710, the method may include transmitting, to a network entity associated with the first cell, a second control message including the traffic information associated with the second cell. The operations of 1710 may be performed in accordance with examples as disclosed herein. In some examples, aspects of the operations of 1710 may be performed by a traffic information transmission component 1230 as described with reference to FIG. 12.

At 1715, the method may include communicating, via the first cell, a message with the network entity, a second set of communication parameters associated with the message based on the traffic information associated with the second cell. The operations of 1715 may be performed in accordance with examples as disclosed herein. In some examples, aspects of the operations of 1715 may be performed by a communication component 1235 as described with reference to FIG. 12.

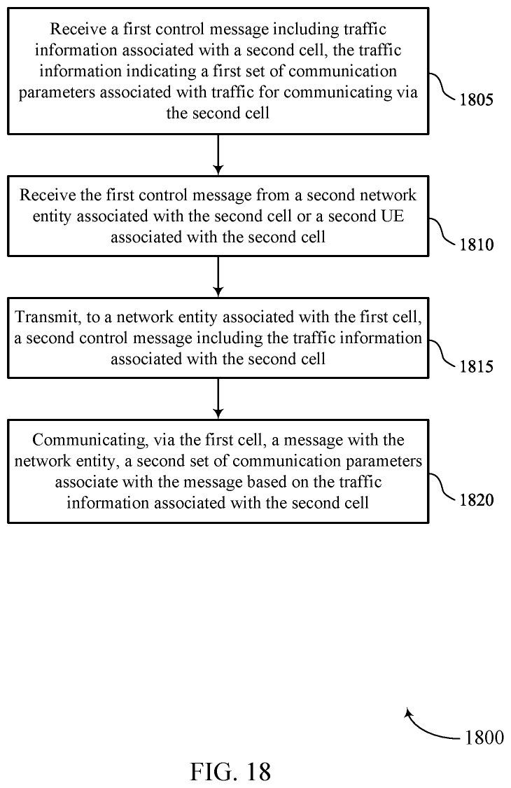

FIG. 18 illustrates a flowchart illustrating a method 1800 that supports techniques for inter-cell traffic coordination in accordance with one or more aspects of the present disclosure. The operations of the method 1800 may be implemented by a UE or its components as described herein. For example, the operations of the method 1800 may be performed by a UE 115 associated with a first cell as described with reference to FIGS. 1 through 5 and 10 through 13. In some examples, a UE may execute a set of instructions to control the functional elements of the UE to perform the described functions. Additionally, or alternatively, the UE may perform aspects of the described functions using special-purpose hardware.

At 1805, the method may include receiving a first control message including traffic information associated with a second cell, the traffic information indicating a first set of communication parameters associated with traffic for communicating via the second cell. The operations of 1805 may be performed in accordance with examples as disclosed herein. In some examples, aspects of the operations of 1805 may be performed by a traffic information reception component 1225 as described with reference to FIG. 12.

At 1810, to support receiving the first control message, the method may include receiving the first control message from a second network entity associated with the second cell or a second UE associated with the second cell. The operations of 1810 may be performed in accordance with examples as disclosed herein. In some examples, aspects of the operations of 1810 may be performed by a traffic information reception component 1225 as described with reference to FIG. 12.

At 1815, the method may include transmitting, to a network entity associated with the first cell, a second control message including the traffic information associated with the second cell. The operations of 1815 may be performed in accordance with examples as disclosed herein. In some examples, aspects of the operations of 1815 may be performed by a traffic information transmission component 1230 as described with reference to FIG. 12.

At 1820, the method may include communicating, via the first cell, a message with the network entity, a second set of communication parameters associated with the message based on the traffic information associated with the second cell. The operations of 1820 may be performed in accordance with examples as disclosed herein. In some examples, aspects of the operations of 1820 may be performed by a communication component 1235 as described with reference to FIG. 12.

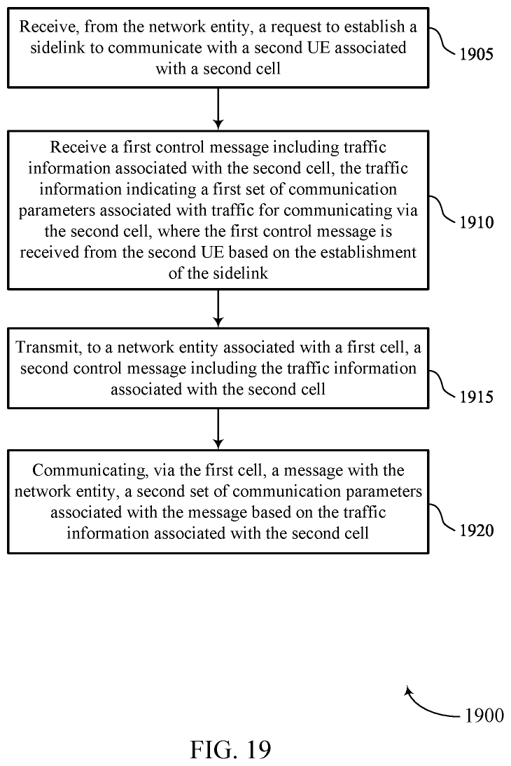

FIG. 19 illustrates a flowchart illustrating a method 1900 that supports techniques for inter-cell traffic coordination in accordance with one or more aspects of the present disclosure. The operations of the method 1900 may be implemented by a UE or its components as described herein. For example, the operations of the method 1900 may be performed by a UE 115 associated with a first cell as described with reference to FIGS. 1 through 5 and 10 through 13. In some examples, a UE may execute a set of instructions to control the functional elements of the UE to perform the described functions. Additionally, or alternatively, the UE may perform aspects of the described functions using special-purpose hardware.

At 1905, the method may include receiving, from the network entity, a request to establish a sidelink to communicate with a second UE associated with a second cell. The operations of 1905 may be performed in accordance with examples as disclosed herein. In some examples, aspects of the operations of 1905 may be performed by a sidelink component 1240 as described with reference to FIG. 12.

At 1910, the method may include receiving a first control message including traffic information associated with a second cell, the traffic information indicating a first set of communication parameters associated with traffic for communicating via the second cell, where the first control message is received from the second UE based on the establishment of the sidelink. The operations of 1910 may be performed in accordance with examples as disclosed herein. In some examples, aspects of the operations of 1910 may be performed by a traffic information reception component 1225 as described with reference to FIG. 12.

At 1915, the method may include transmitting, to a network entity associated with the first cell, a second control message including the traffic information associated with the second cell. The operations of 1915 may be performed in accordance with examples as disclosed herein. In some examples, aspects of the operations of 1915 may be performed by a traffic information transmission component 1230 as described with reference to FIG. 12.

At 1920, the method may include communicating, via the first cell, a message with the network entity, a second set of communication parameters associated with the message based on the traffic information associated with the second cell. The operations of 1920 may be performed in accordance with examples as disclosed herein. In some examples, aspects of the operations of 1920 may be performed by a communication component 1235 as described with reference to FIG. 12.

The following provides an overview of aspects of the present disclosure:

Aspect 1: A method for wireless communication at a network entity associated with a first cell, comprising: obtaining a control message comprising traffic information associated with a second cell, the traffic information indicating a first set of communication parameters associated with traffic for communicating via the second cell; and communicating, via the first cell, a message with a UE associated with the first cell, a second set of communication parameters associated with the message based at least in part on the traffic information associated with the second cell.

Aspect 2: The method of aspect 1, wherein obtaining the control message comprising the traffic information comprises: obtaining the control message comprising the traffic information from a second network entity associated with the second cell.

Aspect 3: The method of any of aspects 1 through 2, wherein obtaining the control message comprising the traffic information comprises: obtaining, via the first cell, the control message comprising the traffic information from the UE or a second UE associated with the first cell.

Aspect 4: The method of aspect 3, further comprising: outputting, to the UE or the second UE, a request to establish a sidelink to communicate with a third UE associated with the second cell, wherein the control message comprising the traffic information is obtained based at least in part on the establishment of the sidelink.

Aspect 5: The method of any of aspects 1 through 4, wherein obtaining the control message comprising the traffic information comprises: obtaining the control message comprising the traffic information from a second UE associated with the second cell.

Aspect 6: The method of any of aspects 1 through 5, further comprising: determining the second set of communication parameters for communicating the message with the UE based at least in part on the first set of communication parameters and a priority associated with the message, a QoS associated with the message, or both.

Aspect 7: The method of aspect 6, wherein the first set of communication parameters comprises a priority associated with the traffic, a QoS associated with the traffic, a MCS associated with the traffic, a transmission power associated with the traffic, a resource configuration associated with the traffic, a reference signal configuration associated with the traffic, a scrambling code associated with the traffic, a TBS associated with the traffic, a BSR associated with the traffic, CSI associated with the second cell, or a combination thereof; and the second set of communication parameters comprises a MCS associated with the message, a transmission power associated with the message, a resource configuration associated with the message, or a combination thereof.

Aspect 8: The method of any of aspects 1 through 7, further comprising: allocating a sidelink resource to the UE for communicating with a second UE via a sidelink based at least in part on the traffic information associated with the second cell.

Aspect 9: The method of any of aspects 1 through 8, further comprising: obtaining, from the UE, a request to adjust a MCS for communicating with the UE based at least in part on the traffic information associated with the second cell, wherein the second set of communication parameters comprises the adjusted MCS based at least in part on the request.

Aspect 10: The method of any of aspects 1 through 9, further comprising: outputting, to the UE based at least in part on the traffic information associated with the second cell, an indication of a time overlap between the message and a second message communicated via the second cell in accordance with the first set of communication parameters, wherein the message is communicated based at least in part on the time overlap.

Aspect 11: The method of aspect 10, wherein the indication of the time overlap comprises a bitmap corresponding to a set of SPS communication occasions between the network entity and the UE or to a set of CG communication occasions between the network entity and the UE, the bitmap indicating that the time overlap occurs during a communication occasion corresponding to the message.

Aspect 12: The method of any of aspects 10 through 11, wherein the indication of the time overlap comprises a SPS configuration associated with the second cell or a CG associated with the second cell, the time overlap corresponding to an overlap between a SPS configuration associated with the first cell and the SPS configuration associated with the second cell or an overlap between a CG associated with the first cell and the CG associated with the second cell.

Aspect 13: The method of any of aspects 1 through 12, further comprising: outputting, to the UE, downlink control information that activates a SPS configuration for communicating with the UE, wherein the downlink control information comprises an indication of a MCS associated with the SPS configuration that is based at least in part on the traffic information associated with the second cell.

Aspect 14: The method of any of aspects 1 through 13, further comprising: outputting, to the UE, a second control message comprising a SPS configuration for communicating with the UE, the SPS configuration comprising an indication for the UE to obtain the traffic information associated with the second cell from a second UE associated with the second cell, wherein the control message is obtained from the UE based at least in part on the SPS configuration.

Aspect 15: The method of aspect 14, wherein the SPS configuration comprises the indication based at least in part on a priority associated with the SPS configuration.

Aspect 16: The method of any of aspects 14 through 15, wherein the SPS configuration comprises a second indication of a duration associated with obtaining the control message from the UE after activation of the SPS configuration, a identifier associated with the second UE, a third indication of a MCS associated with the SPS configuration for communicating to the second UE, or a combination thereof.

Aspect 17: The method of any of aspects 14 through 16, further comprising: outputting, to the UE, downlink control information to activate the SPS configuration, the downlink control information comprising a MCS associated with the SPS configuration for communicating to the second UE.

Aspect 18: The method of any of aspects 1 through 17, wherein the traffic for communicating via the second cell is associated with a zone that comprises the UE and a second UE associated with the second cell based at least in part on respective geographic locations of the UE and the second UE.

Aspect 19: A method for wireless communication at a UE associated with a first cell, comprising: receiving a first control message comprising traffic information associated with a second cell, the traffic information indicating a first set of communication parameters associated with traffic for communicating via the second cell; transmitting, to a network entity associated with the first cell, a second control message comprising the traffic information associated with the second cell; and communicating, via the first cell, a message with the network entity, a second set of communication parameters associated with the message based at least in part on the traffic information associated with the second cell.

Aspect 20: The method of aspect 19, wherein receiving the first control message comprises: receiving the first control message from a second network entity associated with the second cell or a second UE associated with the second cell.

Aspect 21: The method of any of aspects 19 through 20, further comprising: transmitting, to the network entity, a third control message comprising second traffic information associated with uplink communications between the UE and the network entity, wherein the second set of communication parameters are based at least in part on the second traffic information.

Aspect 22: The method of any of aspects 19 through 21, further comprising: receiving, from the network entity, a request to establish a sidelink to communicate with a second UE associated with the second cell, wherein the first control message is received from the second UE based at least in part on the establishment of the sidelink.

Aspect 23: The method of any of aspects 19 through 22, wherein the first set of communication parameters comprises a priority associated with the traffic, a QoS associated with the traffic, a MCS associated with the traffic, a transmission power associated with the traffic, a resource configuration associated with the traffic, a reference signal configuration associated with the traffic, a scrambling code associated with the traffic, a TBS associated with the traffic, a BSR associated with the traffic, CSI associated with the second cell, or a combination thereof; and the second set of communication parameters comprises a MCS associated with the message, a transmission power associated with the message, a resource configuration associated with the message, or a combination thereof.

Aspect 24: The method of any of aspects 19 through 23, further comprising: transmitting, to the network entity, a request to adjust a MCS for communicating with the UE based at least in part on the traffic information associated with the second cell, wherein the second set of communication parameters comprises the adjusted MCS based at least in part on the request.

Aspect 25: The method of any of aspects 19 through 24, further comprising: receiving, from the network entity, an indication of a time overlap between the message and a second message communicated via the second cell in accordance with the first set of communication parameters; and performing an interference cancellation procedure in association with communicating the message based at least in part on the indication of the time overlap and the first set of communication parameters.

Aspect 26: The method of any of aspects 19 through 25, further comprising: receiving, from the network entity, first downlink control information that activates a first SPS configuration for communicating with the network entity; and transmitting, to a second UE associated with the second cell based at least in part on the first downlink control information, a request for the traffic information associated with the second cell, the traffic information associated with the second cell comprising a MCS associated with a second SPS configuration of the second cell, CSI associated with the second cell, or a combination thereof, wherein the first control message is received based at least in part on the request.

Aspect 27: The method of aspect 26, further comprising: transmitting, to the second UE based at least in part on the first downlink control information, a third control message comprising a MCS associated with the first SPS configuration, CSI associated with the first cell, or a combination thereof.

Aspect 28: The method of any of aspects 19 through 27, wherein the traffic for communicating via the second cell is associated with a zone that comprises the UE and a second UE associated with the second cell based at least in part on respective geographic locations of the UE and the second UE.

Aspect 29: An apparatus for wireless communication at a network entity associated with a first cell, comprising a processor; memory coupled with the processor; and instructions stored in the memory and executable by the processor to cause the apparatus to perform a method of any of aspects 1 through 18.

Aspect 30: An apparatus for wireless communication at a network entity associated with a first cell, comprising at least one means for performing a method of any of aspects 1 through 18.

Aspect 31: A non-transitory computer-readable medium storing code for wireless communication at a network entity associated with a first cell, the code comprising instructions executable by a processor to perform a method of any of aspects 1 through 18.

Aspect 32: An apparatus for wireless communication at a UE associated with a first cell, comprising a processor; memory coupled with the processor; and instructions stored in the memory and executable by the processor to cause the apparatus to perform a method of any of aspects 19 through 28.

Aspect 33: An apparatus for wireless communication at a UE associated with a first cell, comprising at least one means for performing a method of any of aspects 19 through 28.

Aspect 34: A non-transitory computer-readable medium storing code for wireless communication at a UE associated with a first cell, the code comprising instructions executable by a processor to perform a method of any of aspects 19 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a network entity associated with a first cell, comprising:
obtaining a control message comprising traffic information associated with a second cell, the traffic information indicating a first set of communication parameters associated with traffic for communicating via the second cell; and
communicating, via the first cell, a message with a user equipment (UE) associated with the first cell, a second set of communication parameters associated with the message based at least in part on the traffic information associated with the second cell.

2. The method of claim 1, wherein obtaining the control message comprising the traffic information comprises:
obtaining the control message comprising the traffic information from a second network entity associated with the second cell.

3. The method of claim 1, wherein obtaining the control message comprising the traffic information comprises:
obtaining, via the first cell, the control message comprising the traffic information from the UE or a second UE associated with the first cell.

4. The method of claim 3, further comprising:
outputting, to the UE or the second UE, a request to establish a sidelink to communicate with a third UE associated with the second cell, wherein the control message comprising the traffic information is obtained based at least in part on the establishment of the sidelink.

5. The method of claim 1, wherein obtaining the control message comprising the traffic information comprises:
obtaining the control message comprising the traffic information from a second UE associated with the second cell.

6. The method of claim 1, further comprising:
determining the second set of communication parameters for communicating the message with the UE based at least in part on the first set of communication parameters and a priority associated with the message, a quality of service associated with the message, or both.

7. The method of claim 6, wherein:
the first set of communication parameters comprises a priority associated with the traffic, a quality of service associated with the traffic, a modulation and coding scheme associated with the traffic, a transmission power associated with the traffic, a resource configuration associated with the traffic, a reference signal configuration associated with the traffic, a scrambling code associated with the traffic, a transport block size associated with the traffic, a buffer status report associated with the traffic, channel state information associated with the second cell, or a combination thereof; and
the second set of communication parameters comprises a modulation and coding scheme associated with the message, a transmission power associated with the message, a resource configuration associated with the message, or a combination thereof.

8. The method of claim 1, further comprising:
allocating a sidelink resource to the UE for communicating with a second UE via a sidelink based at least in part on the traffic information associated with the second cell.

9. The method of claim 1, further comprising:
obtaining, from the UE, a request to adjust a modulation and coding scheme for communicating with the UE based at least in part on the traffic information associated with the second cell, wherein the second set of communication parameters comprises the adjusted modulation and coding scheme based at least in part on the request.

10. The method of claim 1, further comprising:
outputting, to the UE based at least in part on the traffic information associated with the second cell, an indication of a time overlap between the message and a second message communicated via the second cell in accordance with the first set of communication parameters, wherein the message is communicated based at least in part on the time overlap.

11. The method of claim 10, wherein the indication of the time overlap comprises a bitmap corresponding to a set of semi-persistent scheduling communication occasions between the network entity and the UE or to a set of configured grant communication occasions between the network entity and the UE, the bitmap indicating that the time overlap occurs during a communication occasion corresponding to the message.

12. The method of claim 10, wherein the indication of the time overlap comprises a semi-persistent scheduling configuration associated with the second cell or a configured grant associated with the second cell, the time overlap corresponding to an overlap between a semi-persistent scheduling configuration associated with the first cell and the semi-persistent scheduling configuration associated with the second cell or an overlap between a configured grant associated with the first cell and the configured grant associated with the second cell.

13. The method of claim 1, further comprising:
outputting, to the UE, downlink control information that activates a semi-persistent scheduling configuration for communicating with the UE, wherein the downlink control information comprises an indication of a modulation and coding scheme associated with the semi-persistent scheduling configuration that is based at least in part on the traffic information associated with the second cell.

14. The method of claim 1, further comprising:
outputting, to the UE, a second control message comprising a semi-persistent scheduling configuration for communicating with the UE, the semi-persistent scheduling configuration comprising an indication for the UE to obtain the traffic information associated with the second cell from a second UE associated with the second cell, wherein the control message is obtained from the UE based at least in part on the semi-persistent scheduling configuration.

15. The method of claim 14, wherein the semi-persistent scheduling configuration comprises the indication based at least in part on a priority associated with the semi-persistent scheduling configuration.

16. The method of claim 14, wherein the semi-persistent scheduling configuration comprises a second indication of a duration associated with obtaining the control message from the UE after activation of the semi-persistent scheduling configuration, an identifier associated with the second UE, a third indication of a modulation and coding scheme associated with the semi-persistent scheduling configuration for communicating to the second UE, or a combination thereof.

17. The method of claim 14, further comprising:
outputting, to the UE, downlink control information to activate the semi-persistent scheduling configuration, the downlink control information comprising a modulation and coding scheme associated with the semi-persistent scheduling configuration for communicating to the second UE.

18. The method of claim 1, wherein the traffic for communicating via the second cell is associated with a zone that comprises the UE and a second UE associated with the second cell based at least in part on respective geographic locations of the UE and the second UE.

19. A method for wireless communication at a user equipment (UE) associated with a first cell, comprising:
receiving a first control message comprising traffic information associated with a second cell, the traffic information indicating a first set of communication parameters associated with traffic for communicating via the second cell;
transmitting, to a network entity associated with the first cell, a second control message comprising the traffic information associated with the second cell; and
communicating, via the first cell, a message with the network entity, a second set of communication parameters associated with the message based at least in part on the traffic information associated with the second cell.

20. The method of claim 19, wherein receiving the first control message comprises:
receiving the first control message from a second network entity associated with the second cell or a second UE associated with the second cell.

21. The method of claim 19, further comprising:
transmitting, to the network entity, a third control message comprising second traffic information associated with uplink communications between the UE and the network entity, wherein the second set of communication parameters are based at least in part on the second traffic information.

22. The method of claim 19, further comprising:
receiving, from the network entity, a request to establish a sidelink to communicate with a second UE associated with the second cell, wherein the first control message is received from the second UE based at least in part on the establishment of the sidelink.

23. The method of claim 19, wherein:
the first set of communication parameters comprises a priority associated with the traffic, a quality of service associated with the traffic, a modulation and coding scheme associated with the traffic, a transmission power associated with the traffic, a resource configuration associated with the traffic, a reference signal configuration associated with the traffic, a scrambling code associated with the traffic, a transport block size associated with the traffic, a buffer status report associated with the traffic, channel state information associated with the second cell, or a combination thereof; and
the second set of communication parameters comprises a modulation and coding scheme associated with the message, a transmission power associated with the message, a resource configuration associated with the message, or a combination thereof.

24. The method of claim 19, further comprising:
transmitting, to the network entity, a request to adjust a modulation and coding scheme for communicating with the UE based at least in part on the traffic information associated with the second cell, wherein the second set of communication parameters comprises the adjusted modulation and coding scheme based at least in part on the request.

25. The method of claim 19, further comprising:
receiving, from the network entity, an indication of a time overlap between the message and a second message communicated via the second cell in accordance with the first set of communication parameters; and
performing an interference cancellation procedure in association with communicating the message based at least in part on the indication of the time overlap and the first set of communication parameters.

26. The method of claim 19, further comprising:
receiving, from the network entity, first downlink control information that activates a first semi-persistent scheduling configuration for communicating with the network entity; and
transmitting, to a second UE associated with the second cell based at least in part on the first downlink control information, a request for the traffic information associated with the second cell, the traffic information associated with the second cell comprising a modulation and coding scheme associated with a second semi-persistent scheduling configuration of the second cell, channel state information associated with the second cell, or a combination thereof,
wherein the first control message is received based at least in part on the request.

27. The method of claim 26, further comprising:
transmitting, to the second UE based at least in part on the first downlink control information, a third control message comprising a modulation and coding scheme associated with the first semi-persistent scheduling configuration, channel state information associated with the first cell, or a combination thereof.

28. The method of claim 19, wherein the traffic for communicating via the second cell is associated with a zone that comprises the UE and a second UE associated with the second cell based at least in part on respective geographic locations of the UE and the second UE.

29. An apparatus for wireless communication at a network entity associated with a first cell, comprising:
a processor;
memory coupled with the processor; and
instructions stored in the memory and executable by the processor to cause the apparatus to:
obtain a control message comprising traffic information associated with a second cell, the traffic information indicating a first set of communication parameters associated with traffic for communicating via the second cell; and
communicating, via the first cell, a message with a user equipment (UE) associate with the first cell, a second set of communication parameters associated with the message based at least in part on the traffic information associated with the second cell.

30. An apparatus for wireless communication at a user equipment (UE) associated with a first cell, comprising:
a processor;
memory coupled with the processor; and
instructions stored in the memory and executable by the processor to cause the apparatus to:
receive a first control message comprising traffic information associated with a second cell, the traffic information indicating a first set of communication parameters associated with traffic for communicating via the second cell;
transmit, to a network entity associated with the first cell, a second control message comprising the traffic information associated with the second cell; and
communicating, via the first cell, a message with the network entity, a second set of communication parameters associated with the message based at least in part on the traffic information associated with the second cell.
